(19) United States
(12) Patent Application Publication
(10) Pub. No.: US 2017/0207889 A1
(43) Pub. Date: Jul. 20, 2017

(54) DEVICE

(71) Applicant: SONY CORPORATION, Tokyo (JP)

(72) Inventor: Nishiki MIZUSAWA, Kanagawa (JP)

(73) Assignee: SONY CORPORATION, Tokyo (JP)

(21) Appl. No.: 15/326,331

(22) PCT Filed: Jun. 16, 2015
(86) PCT No.: PCT/JP2015/003002

§ 371 Date: Jan. 13, 2017

(30) Foreign Application Priority Data
Jul. 22, 2014 (JP) 2014-148820

(51) Int. Cl. H04L 5/00; H04L 5/16; H04W 72/04; H04L 5/14

(52) U.S. Cl. CPC H04L 5/0042; H04L 5/14; H04L 5/16; H04W 72/0446; H04L 5/0055; H04L 5/001

(57) ABSTRACT

A device including an acquisition unit configured to acquire information indicating an uplink/downlink configuration of a time division duplex (TDD), and a control unit configured to notify the uplink/downlink configuration to a terminal device. The control unit controls radio communication in a half duplex frequency division duplex (HD-FDD) with respect to the terminal device according to the uplink/downlink configuration.

### CROSS REFERENCE TO RELATED APPLICATIONS

This application claims the benefit of Japanese Priority Patent Application JP 2014-148820 filed Jul. 22, 2014, the entire contents of which are incorporated herein by reference.

### TECHNICAL FIELD

The present disclosure relates to a device.

### BACKGROUND ART

A long term evolution (LTE) supports a frequency division duplex (FDD) and a time division duplex (TDD) as a duplex scheme. Furthermore, the LTE supports both of a full duplex (FD) and a half duplex (HD) for the FDD. In other words, the LTE supports both of an FD-FDD and an HD-FDD. In a case where a terminal device has a function of the FD, transmission and reception both can be simultaneously performed. On the other hand, in a case where the terminal device has only a function of the HD, the transmission and the reception are not simultaneously performed. The HD-FDD reduces a data rate of the terminal device, but can make the terminal device reduced in cost. For example, the terminal device supporting only the HD-FDD does not necessarily have a duplexer, and does not require a plurality of local transmitters (that is, only one local transmitter is required). In addition, in the terminal device which performs an HD-FDD operation, a signal processing amount is reduced compared to the terminal which performs an FD-FDD operation.

For example, a base station enables the HD-FDD operation by performing scheduling such that a radio resource of the uplink and a radio resource of the downlink both are not simultaneously assigned to the terminal device which performs the HD-FDD operation. Some other technologies are proposed for the HD-FDD.

For example, in NPLs 1 and 2, the number of hybrid automatic repeat-request (HARQ) processes required for the terminal device which performs the HD-FDD operation is proposed. Specifically, there is proposed a technology in which the number of HARQ processes of each of the uplink and the downlink is set to 3 on the existing assumption of the FDD in which the scheduling information of the uplink is transmitted or received by a subframe before four subframes compared to the transceiving of the uplink data, and the ACK/NACK is transmitted or received by a subframe after four subframes compared to the transceiving of the data.

### CITATION LIST

### Non Patent Literature

NPL 1: 3GPP TSG RAN WG1 Meeting #76bis, Shenzhen, China, 31 Mar. to 4 Apr. 2014, CATT, “Number of HARQ processes for low complexity HD-FDD UEs” NPL 2: 3GPP TSG RAN WG1 Meeting #76bis, Shenzhen, P.R. China, 31 Mar. to 4 Apr. 2014, Ericsson, “Half duplex FDD for low cost MTC UE”

### SUMMARY

### Technical Problem

In a case where the terminal device supporting the TDD is positioned within a cell of the TDD, radio communication can be performed, but in a case where the terminal device supporting the TDD is positioned within the FDD for example, the radio communication is difficult to be performed. For example, the terminal device supporting the TDD necessarily performs the HD-FDD operation greatly different from a TDD operation as well as the switching of the frequency of a local oscillator in order to perform the HD-FDD operation as disclosed in the above non-patent literatures. Therefore, a process of the terminal device may become complicated.

For this reason, it is preferably provided a structure in which the terminal device supporting the TDD can more easily perform the radio communication in a cell of the FDD.

### Solution to Problem

According to an embodiment of the present disclosure, there is provided a device including: circuitry configured to receive information indicating an uplink/downlink configuration of a TDD; provide the uplink/downlink configuration to a terminal device; and control radio communication in a half duplex frequency division duplex (HD-FDD) with the terminal device according to the uplink/downlink configuration.

According to another embodiment of the present disclosure, there is provided a device including: circuitry configured to receive an uplink/downlink configuration of a time division duplex (TDD) from a base station; and control radio communication in a half duplex frequency division duplex (HD-FDD) with the base station according to the uplink/downlink configuration.

According to another embodiment of the present disclosure, there is provided a base station including: an antenna; and circuitry configured to receive information indicating an uplink/downlink configuration of a time division duplex (TDD); provide the uplink/downlink configuration to a terminal device; and control radio communication, via the antenna, in a half duplex frequency division duplex (HD-FDD) with the terminal device according to the uplink/downlink configuration.

According to another embodiment of the present disclosure, there is provided a terminal device including an antenna; and circuitry configured to receive an uplink/downlink configuration of a time division duplex (TDD) from a base station; and control radio communication, via the antenna, in a half duplex frequency division duplex (HD-FDD) with the base station according to the uplink/downlink configuration.

### Advantageous Effects of Invention

According to an embodiment of the present disclosure as described above, a radio resource can be more flexibly assigned to the terminal device. Further, according to an embodiment of the present disclosure, the terminal device supporting the TDD can more easily perform the radio communication in a cell of the FDD. Note that the above advantages are not necessarily limiting. In addition to or instead of the above advantages, any advantages described in the present specification or other advantages derived from the present specification may be achieved.

### BRIEF DESCRIPTION OF DRAWINGS

FIG. 1 is an explanatory diagram for describing an example of radio communication in an FDD.

FIG. 2 is an explanatory diagram for describing an example of radio communication in a TDD.

FIG. 3 is an explanatory diagram for describing an example of radio communication in an HD-FDD.

FIG. 4 is a flowchart illustrating an example of a schematic flow of an operation of the HD-FDD from cell search to transmission of capability information.

FIG. 5 is an explanatory diagram for describing locations of a PSS and an SSS in the FDD.

FIG. 6 is a flowchart illustrating an example of a schematic flow of a process of radio communication in the HD-FDD.

FIG. 7 is a flowchart illustrating an example of a schematic flow of a process of radio communication in an FD-FDD.

FIG. 8 is a flowchart illustrating an example of a schematic flow of a TDD operation from cell search to transmission of capability information.

FIG. 9 is an explanatory diagram for describing locations of the PSS and the SSS in the TDD.

FIG. 10 is a flowchart illustrating an example of a schematic flow of a process of radio communication in the TDD.

FIG. 11 is an explanatory diagram for describing a UL/DL configuration of the TDD.

FIG. 12 is an explanatory diagram for describing an example of a subframe in which downlink data is transmitted and a subframe in which an ACK/NACK is transmitted in response to the downlink data.

FIG. 13 is an explanatory diagram for describing an example of a subframe in which uplink data is transmitted and a subframe in which an ACK/NACK is transmitted in response to the uplink data.

FIG. 14 is an explanatory diagram for describing an example of ACK/NACK transmission in a case of carrier aggregation.

FIG. 15 is an explanatory diagram illustrating an example of a schematic configuration of a communication system according to an embodiment of the present disclosure.

FIG. 16 is an explanatory diagram for describing an example of a case where a base station is a base station of a macro cell.

FIG. 17 is an explanatory diagram for describing a CC of the FDD and a CC of the TDD.

FIG. 18 is a block diagram illustrating an example of a configuration of a base station according to the embodiment.

FIG. 19 is an explanatory diagram for describing an example of assigning radio resources to a terminal device.

FIG. 20 is an explanatory diagram for describing a first example of an ACK/NACK transmission subframe which is predetermined for the UL/DL configuration.

FIG. 21 is an explanatory diagram for describing a second example of an ACK/NACK transmission subframe which is predetermined for the UL/DL configuration.

FIG. 22 is an explanatory diagram for describing a third example of an ACK/NACK transmission subframe which is predetermined for the UL/DL configuration.

FIG. 23 is a block diagram illustrating an example of a configuration of a terminal device according to the embodiment.

FIG. 24 is an explanatory diagram for describing an example of hardware which is included in a radio communication unit of the terminal device of the embodiment.

FIG. 25 is a sequence diagram illustrating an example of a schematic flow of a process of the base station and the terminal device according to the embodiment.

FIG. 26 is a flowchart illustrating an example of a schematic flow of a first process of the terminal device according to the embodiment.

FIG. 27 is a flowchart illustrating an example of a schematic flow of a second process of the terminal device according to the embodiment.

FIG. 28 is an explanatory diagram for describing a first example of ACK/NACK transmission according to a modification of the embodiment.

FIG. 29 is an explanatory diagram for describing a second example of ACK/NACK transmission according to a modification of the embodiment.

FIG. 30 is an explanatory diagram for describing an example of a primary cell and a secondary cell.

FIG. 31 is an explanatory diagram for describing an example of a macro cell and a small cell in a fourth modification.

FIG. 32 is a block diagram illustrating a first example of a schematic configuration of an eNB.

FIG. 33 is a block diagram illustrating a second example of a schematic configuration of an eNB.

FIG. 34 is a block diagram illustrating an example of a schematic configuration of a smartphone.

FIG. 35 is a block diagram illustrating an example of a schematic configuration of a car navigation apparatus.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the following description is given in the order as follows.

1. Introduction

1.1. Relevant Technology

1.2. Technical Problem

2. Schematic Configuration of Communication System

3. Configurations of Devices

3.1. Configuration of Base Station

3.2. Configuration of Terminal Device

4. Flow of Process

5. Modification

5.1. Common Feature in Modifications

5.2. First Modification

5.3. Second Modification

5.4. Third Modification

5.5. Fourth Modification

5.6. Fifth Modification

6. Application

6.1. Application to Base Station

6.2. Application to Terminal Device

7. Conclusion

<<1. Introduction>>

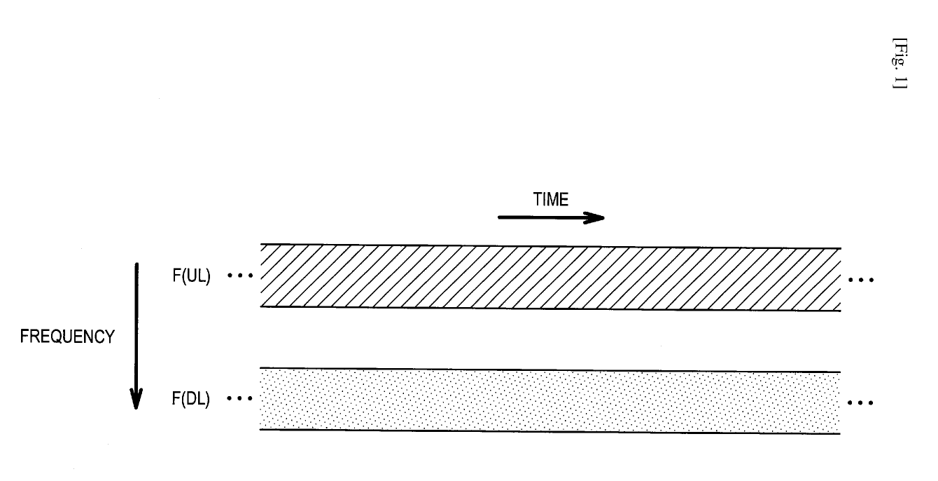

First, a relevant technology and a technical problem of an embodiment of the present disclosure will be described with reference to FIGS. 1 to 14.

<1.1. Relevant Technology>

A relevant technology of the embodiment of the present disclosure will be described with reference to FIGS. 1 to 11.

(FDD/TDD)

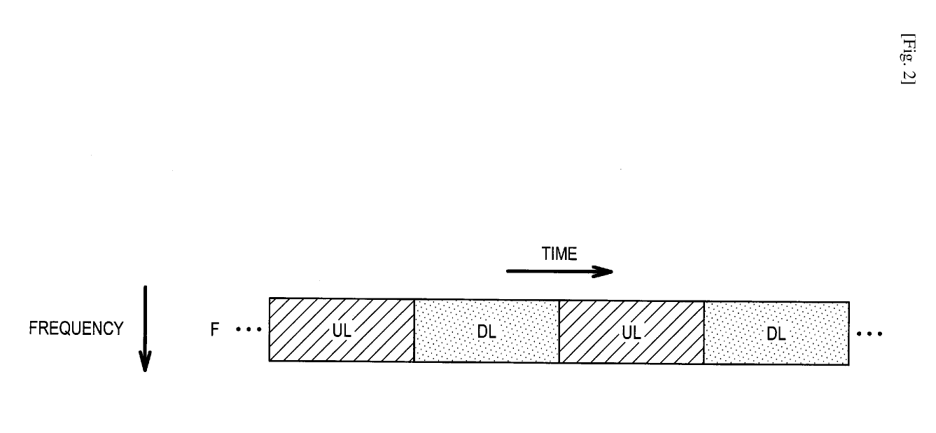

LTE is a duplex scheme, and supports a frequency division duplex (FDD) and a time division duplex (TDD). Hereinafter, an example of radio communication in the FDD and radio communication in the TDD will be described with reference to FIGS. 1 and 2.

FIG. 1 is an explanatory diagram for describing an example of the radio communication in the FDD. Referring to FIG. 1, a pair of an uplink bandwidth F(UL) and a downlink bandwidth F(DL) of the FDD is illustrated. In the radio communication of the FDD, the uplink bandwidth F(UL) is used for uplink at any time, and the downlink bandwidth F(DL) is used for downlink at any time.

FIG. 2 is an explanatory diagram for describing an example of the radio communication in the TDD. Referring to FIG. 2, a bandwidth F of the TDD is illustrated. In the radio communication of the TDD, the bandwidth F is used for the uplink at a certain time, and used for the downlink at another time.

(Differences Between FDD and TDD)

There are some differences between a FDD system and a TDD system. Therefore, a terminal device supporting the TDD is operated in the TDD system, but not possible to be operated in the FDD system.

Firstly, in the FDD, frequency bandwidths used in the uplink and the downlink are different, but in the TDD, the frequency bandwidths used in the uplink and the downlink are the same.

Secondly, in the FDD and the TDD, a location in a time area where a synchronization signal is transmitted is different. Specifically, in the FDD and the TDD, symbols to transmit a primary synchronization signal (PSS) and a secondary synchronization signal (SSS) are different.

Thirdly, in the FDD and the TDD, a timing of an HARQ acknowledgement and a timing of notifying an assignment of radio resources of the uplink to the terminal device are different.

Fourthly, in the TDD, an uplink/downlink configuration (hereinafter, referred to as a “UL/DL configuration”) in which an uplink subframe, a downlink subframe, and a special subframe are determined is notified to the terminal device by a base station. Then, the uplink and the downlink are switched according to the UL/DL configuration.

On the other hand, in the FDD, the radio communication of the uplink is possible even at any time in the uplink bandwidth, and the radio communication of the downlink is possible even at any time in the downlink bandwidth.

(FD/HD)

The LTE supports both full duplex communication (FD) and half duplex communication (HD) in the FDD. In other words, the LTE supports both an FD-FDD and an HD-FDD.

In a case where the terminal device has a function of FD, transmission and reception both can be performed at the same time. Referring to FIG. 1 again, for example, the terminal device performing an FD-FDD operation can simultaneously perform the uplink transmission in the uplink bandwidth F(UL) and the downlink reception in the downlink bandwidth F(DL).

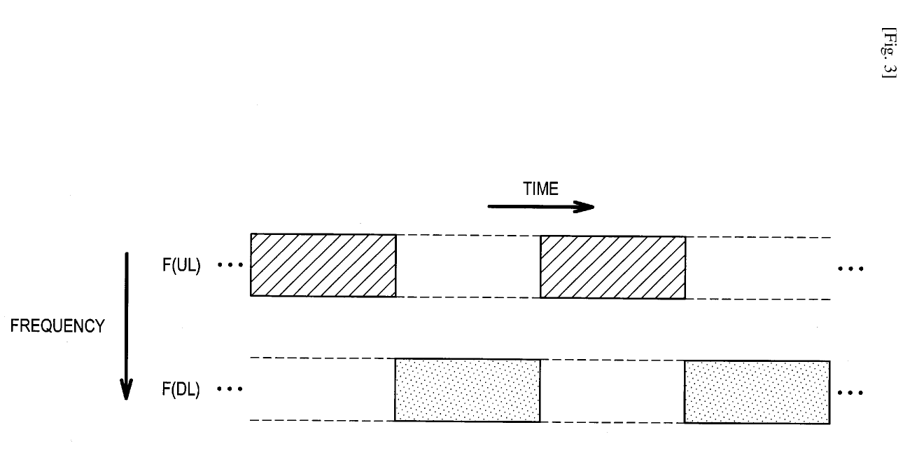

On the other hand, in a case where the terminal device has only a function of HD, the transmission and the reception are not performed at the same time. Hereinafter, a specific example of such a configuration will be described with reference to FIG. 3.

FIG. 3 is an explanatory diagram for describing an example of the radio communication in the HD-FDD. Referring to FIG. 3, a pair of the uplink bandwidth F(UL) and the downlink bandwidth F(DL) of the FDD is illustrated. The terminal device performing an HD-FDD operation performs both the uplink transmission in the uplink bandwidth F(UL) and the downlink reception in the downlink bandwidth F(DL) at the same time. In other words, the terminal device performs the uplink transmission at a certain time, and performs the downlink reception at another time.

The HD-FDD degrades the data rate of the terminal device, but can reduce a cost of the terminal device. For example, the terminal device supporting only the HD-FDD may be not provided with a duplexer, and does not require a plurality of local transmitters (that is, only one local transmitter is required). In addition, the terminal device performing the HD-FDD operation processes a lot of signals compared to the terminal device performing the FD-FDD operation.

(Capability)

In the LTE, user equipment (UE) transmits a UE capability information message indicating a terminal category and various types of capabilities supported by the UE to an evolved node B (eNB).

For example, a supported band list includes operating band numbers of the FDD and the TDD supported by the UE, and indicates whether the UE supports only the HD or the UE supports the FD with respect to the operating band.

For example, support band combinations indicate combinations of bands which support the carrier aggregation with respect to each of the downlink and the uplink

(HD-FDD Operation)

Operation from Cell Search to Transmission of Capability Information

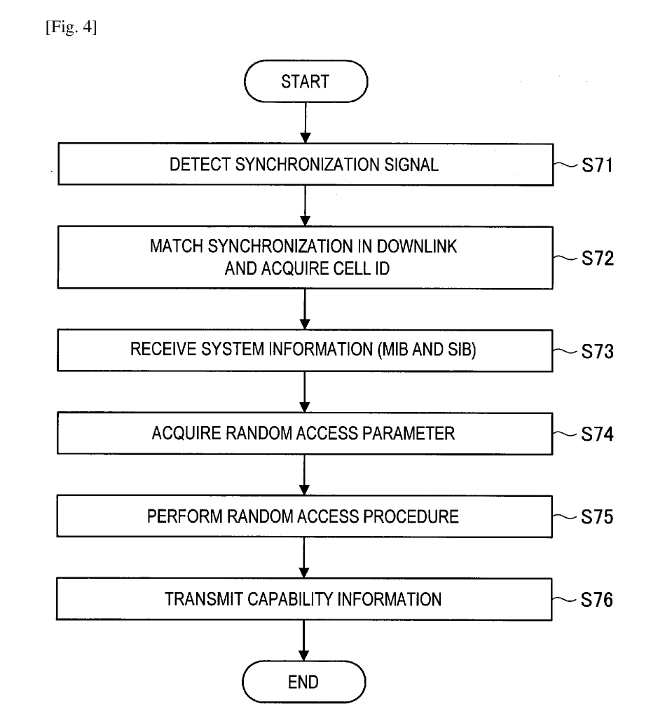

FIG. 4 is a flowchart illustrating an example of a schematic flow of the HD-FDD operation from the cell search to the transmission of the capability information.

The UE holds a list of frequencies which are targets of the cell search in advance. Therefore, the UE receives a downlink signal according to the list and detects a synchronization signal contained in the received downlink signal (S71). The synchronization signal includes the PSS and the SSS. The UE matches synchronization in the downlink based on the synchronization signal, and acquires a cell ID (S72).

Furthermore, the UE receives system information (S73). The system information includes a master information block (MIB) and a system information block (SIB). The UE acquires a random access parameter from the system information (S74).

Then, the UE performs a random access procedure (S75).

Furthermore, the UE transmits the capability information indicating a capability of the UE to the eNB in response to a request from the eNB (S76). For example, the capability information is the UE capability information message. The UE notifies whether the UE supports only the HD or the UE supports the FD to the eNB by transmitting the capability information. Then, the process is ended.

Further, in a case where the terminal device supports only the HD with respect to the operating band used by the base station, the base station performs scheduling such that both of the radio resource of the uplink and the radio resource of the downlink of the same subframe are not assigned to the terminal device.

In Step S71 described above, the radio resource used in the transmission of the synchronization signal is determined in advance. Therefore, the UE can recognize a timing of the head of a radio frame by specifying locations of the PSS and the SSS (that is, the radio resources used in transmission of the PSS and the SSS).

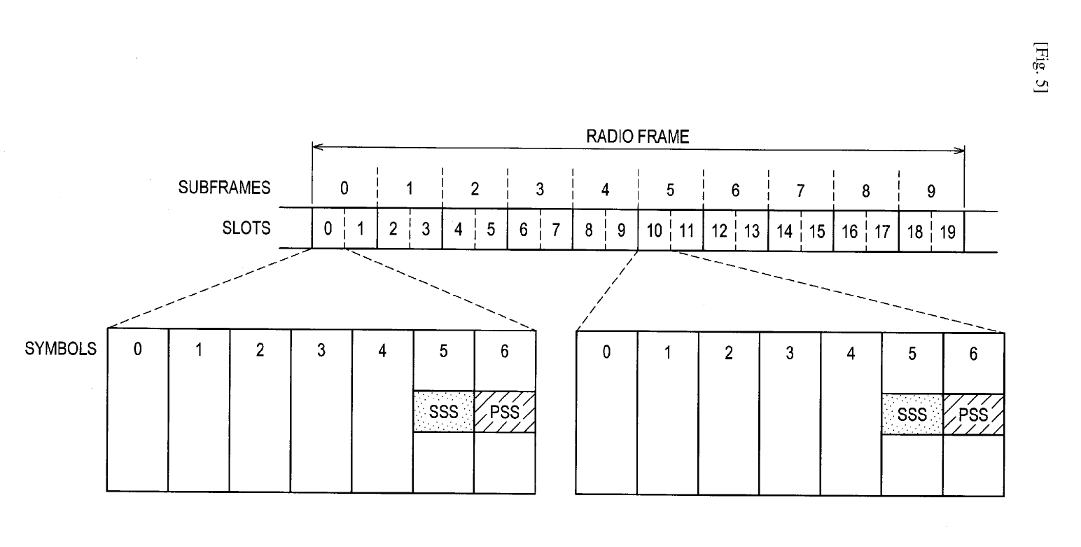

FIG. 5 is an explanatory diagram for describing the locations of the PSS and the SSS in the FDD. Referring to FIG. 5, a 10-ms radio frame and ten subframes included in the radio frame are illustrated. Each subframe includes two slots (that is, a first slot and a second slot), and each slot includes seven symbols. For example, in the FDD, the SSS is transmitted by the sixth symbol in the first slot of a subframe having a subframe number of 0, and the PSS is transmitted by the seventh symbol. In addition, also in the first slot of a subframe having a subframe number of 5, the SSS is transmitted the sixth symbol, and the PSS is transmitted by the seventh symbol.

Radio Communication in HD-FDD

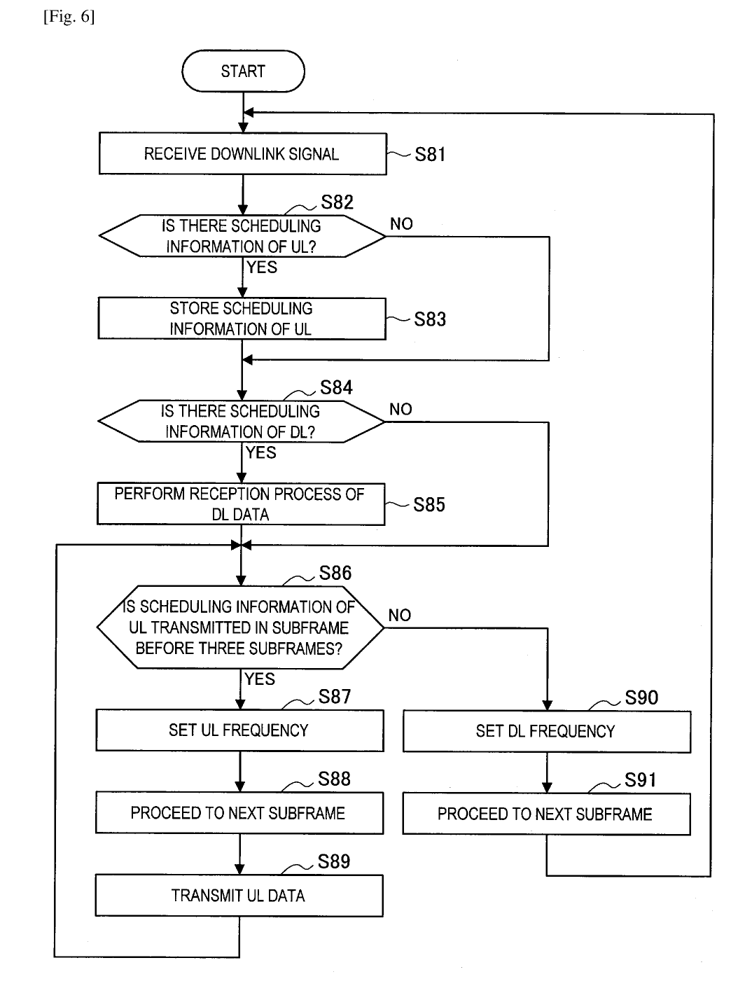

FIG. 6 is a flowchart illustrating an example of a schematic flow of the radio communication in the HD-FDD.

The UE receives the downlink signal (S81). The downlink signal includes a signal indicating downlink control information transmitted by a physical downlink control channel (PDCCH).

In a case where there is scheduling information of the uplink for the UE in the downlink control information (YES in S82), the UE stores the scheduling information of the uplink (S83).

In a case where there is scheduling information of the downlink for the UE in the downlink control information (YES in S84), the UE performs a reception process of downlink data addressed to the UE (S85).

In a case where the scheduling information of the uplink is transmitted in a subframe before three subframes (YES in S86), the UE sets an uplink frequency (S87). Further, in a case where the uplink frequency is already set, the UE may be not set a new uplink frequency. Then, when the next subframe is arrived (S88), the UE transmits uplink data (S89). Then, the process returns to Step S86.

On the other hand, in a case where the scheduling information of the uplink is not transmitted in a subframe before three subframes (NO in S86), the UE sets a downlink frequency (S90). Then, the next subframe becomes a target (S91), and the process returns to Step S81.

(FD-FDD Operation)

Operation from Cell Search to Transmission of Capability Information

The description on the FD-FDD operation from the cell search to the transmission of the capability information is the same as the description of the above-mentioned HD-FDD operation from the cell search to the transmission of the capability information. Therefore, the redundant description herein will not be repeated.

Radio Communication in FD-FDD

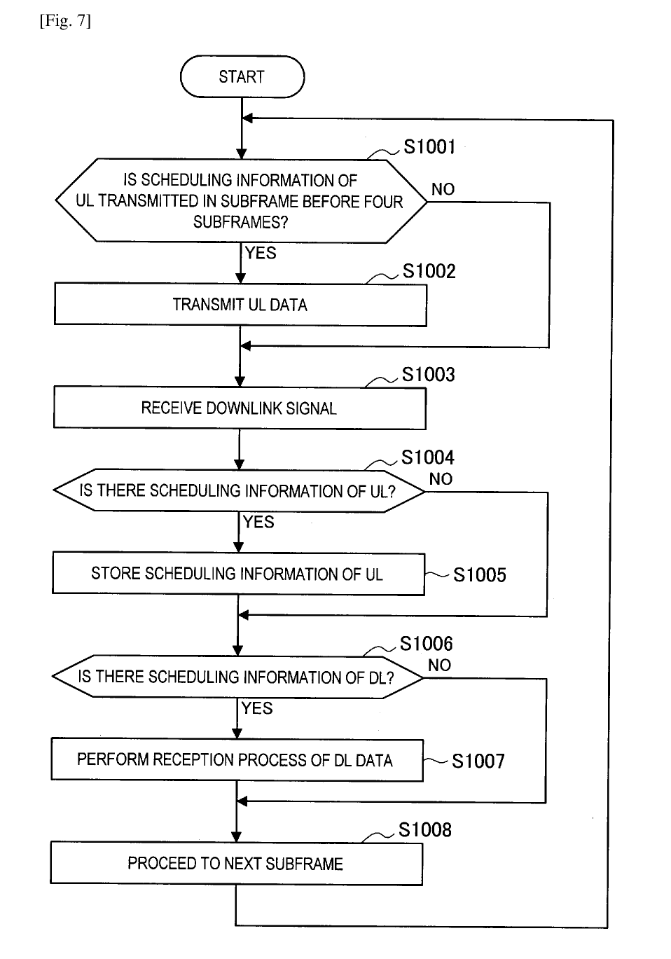

FIG. 7 is a flowchart illustrating an example of a schematic flow of a process of the radio communication in the FD-FDD.

In a case where the scheduling information of the uplink is transmitted in a subframe before four subframes (YES in S1001), the UE transmits the uplink data (S1002).

The UE receives the downlink signal (S1003). The downlink signal includes a signal indicating the downlink control information transmitted by the PDCCH.

In a case where there is scheduling information of the uplink for the UE in the downlink control information (YES in S1004), the UE stores the scheduling information of the uplink (S1005).

In a case where there is the scheduling information of the downlink for the UE in the downlink control information (YES in S1006), the UE performs the reception process of the downlink data addressed to the UE (S1007). Then, the next subframe becomes a target (S1008), and the process returns to Step S1001.

(TDD Operation)

Operation from Cell Search to Transmission of Capability Information

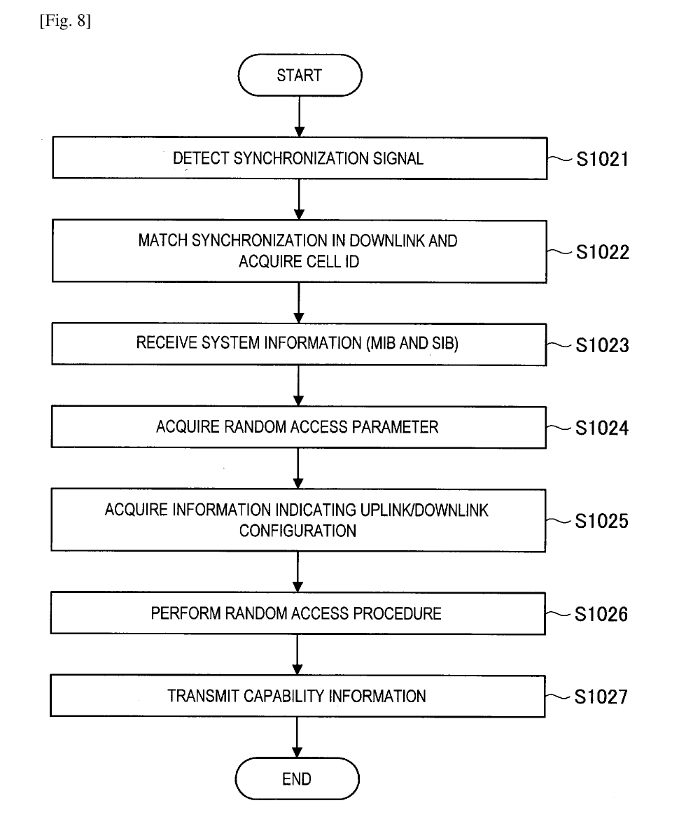

FIG. 8 is a flowchart illustrating an example of a scheduling flow of a TDD operation from the cell search to the transmission of the capability information.

The UE holds a list of frequencies which are targets of the cell search in advance. Therefore, the UE receives the downlink signal according to the list and detects the synchronization signal contained in the received downlink signal (S1021). The synchronization signal includes the PSS and the SSS. The UE matches synchronization in the downlink based on the synchronization signal, and acquires the cell ID (S1022).

Furthermore, the UE receives the system information (S1023). The system information includes the MIB and the SIB. The UE acquires the random access parameter from the system information (S1024). Furthermore, the UE acquires information indicating the UL/DL configuration of the TDD from the system information (S1025).

Then, the UE performs the random access procedure (S1026).

Furthermore, the UE transmits the capability information indicating a capability of the UE to the eNB in response to the request from the eNB (S1027). For example, the capability information is the UE capability information message. Then, the process is ended.

In Step S1021 described above, the radio resource used in the transmission of the synchronization signal is determined in advance. Therefore, the UE can recognize a timing of the head of a radio frame by specifying locations of the PSS and the SSS (that is, the radio resources used in transmission of the PSS and the SSS).

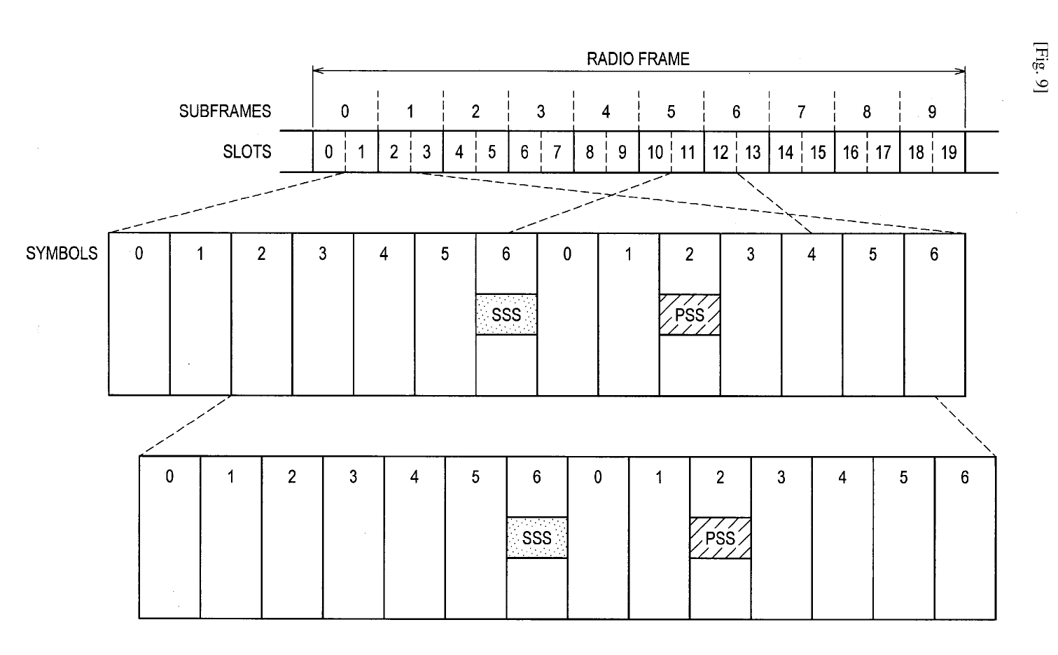

FIG. 9 is an explanatory diagram for describing the locations of the PSS and the SSS in the TDD. Referring to FIG. 9, a 10-ms radio frame and ten subframes included in the radio frame are illustrated. Each subframe includes two slots (that is, the first slot and the second slot), and each slot includes seven symbols. For example, in the TDD, the SSS is transmitted by the seventh symbol in the second slot of a subframe having a subframe number of 0, and the PSS is transmitted by the third symbol in the first slot of a subframe having a subframe number of 1. In addition, the SSS is transmitted by the seventh symbol in the second slot of a subframe having a subframe number of 5, and the PSS is transmitted by the third symbol in the first slot of a subframe having a subframe number of 6.

Radio Communication in TDD

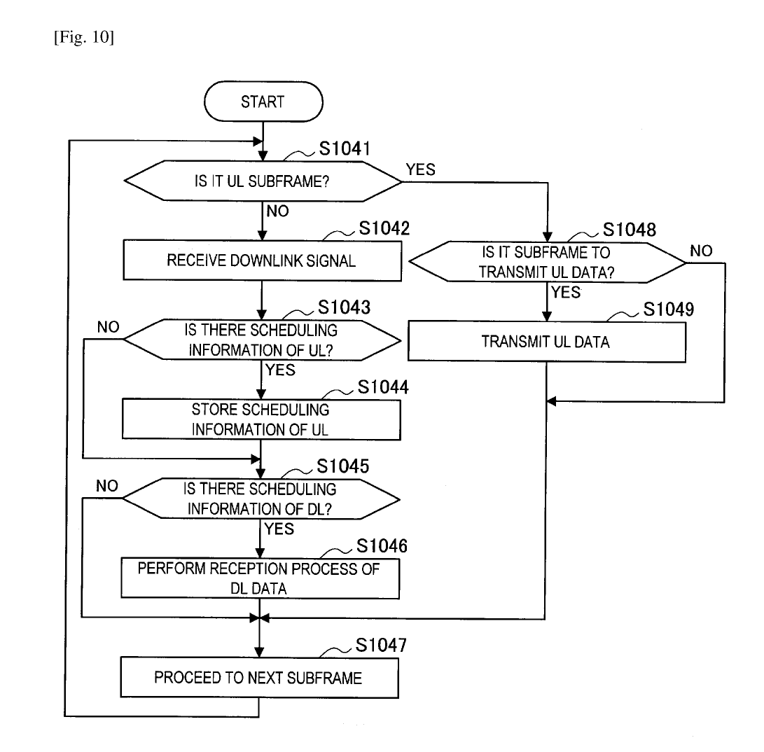

FIG. 10 is a flowchart illustrating an example of a schematic flow of a process of the radio communication in the TDD.

In a case where the subframe is not an uplink subframe (that is, the subframe is a downlink subframe or special subframe) (NO in S1041), the UE receives the downlink signal (S1042). The downlink signal includes a signal of the downlink control information transmitted by the PDCCH.

In a case where there is scheduling information of the uplink for the UE in the downlink control information (YES in S1043), the UE stores the scheduling information of the uplink (S1044).

In a case where there is the scheduling information of the downlink for the UE in the downlink control information (YES in S1045), the UE performs the reception process of the downlink data addressed to the UE (S1046). Then, the next subframe becomes a target (S1047), and the process returns to Step S1041.

In a case where the subframe is an uplink subframe (YES in S1041) and the UE is a subframe to transmit the uplink data (YES in S1048), the UE transmits the uplink data (S1049). Then, the next subframe becomes a target (S1047), and the process returns to Step S1041.

(HARQ)

(a) Difference Between FDD and TDD

In the FDD, an HARQ acknowledgement of the downlink data is transmitted in the uplink in a subframe after four subframes in which the downlink data is transmitted. In addition, the HARQ acknowledgement of the uplink data is transmitted in the downlink in a subframe after four subframes in which the uplink data is transmitted.

In the TDD, the subframe in which the HARQ acknowledgement is transmitted is different according to the UL/DL configuration of the TDD. In addition, the subframe is determined in advance for the UL/DL configuration of the TDD. A subframe in which an ACK/NACK of the downlink data is transmitted is defined in Table 10.1.3.1-1 of 3GPP TS36.213. The subframe in which an ACK/NACK of the uplink data is transmitted is defined in Table 9.1.2-1 of 3GPP TS36.213.

(b) Case of Carrier Aggregation

In the carrier aggregation, uplink control information of a secondary component carrier (SCC) (that is, a secondary cell) of the UE is transmitted by a physical uplink control channel (PUCCH) of a primary component carrier (that is, a primary cell) of the UE. Therefore, the PUCCH is not disposed in the SCC.

The uplink control information includes the HARQ acknowledgement. In other words, the ACK/NACK of the downlink transmitted by the SCC is transmitted by the PUCCH of the PCC.

Further, the uplink control information includes also a special link request and/or channel state information (CSI).

(Transmission of Scheduling Information of Uplink)

In the FDD, the scheduling information of the uplink is transmitted to the UE in a subframe before four subframes at a location where the radio resource is assigned to the UE.

In the TDD, a subframe in which the scheduling information of the uplink is transmitted is different according to the UL/DL configuration of the TDD. In addition, the subframe is determined in advance for the UL/DL configuration of the TDD. The subframe in which the scheduling information of the uplink is transmitted is defined in Table 8-2 of 3GPP TS36.213.

(UL/DL Configuration of TDD)

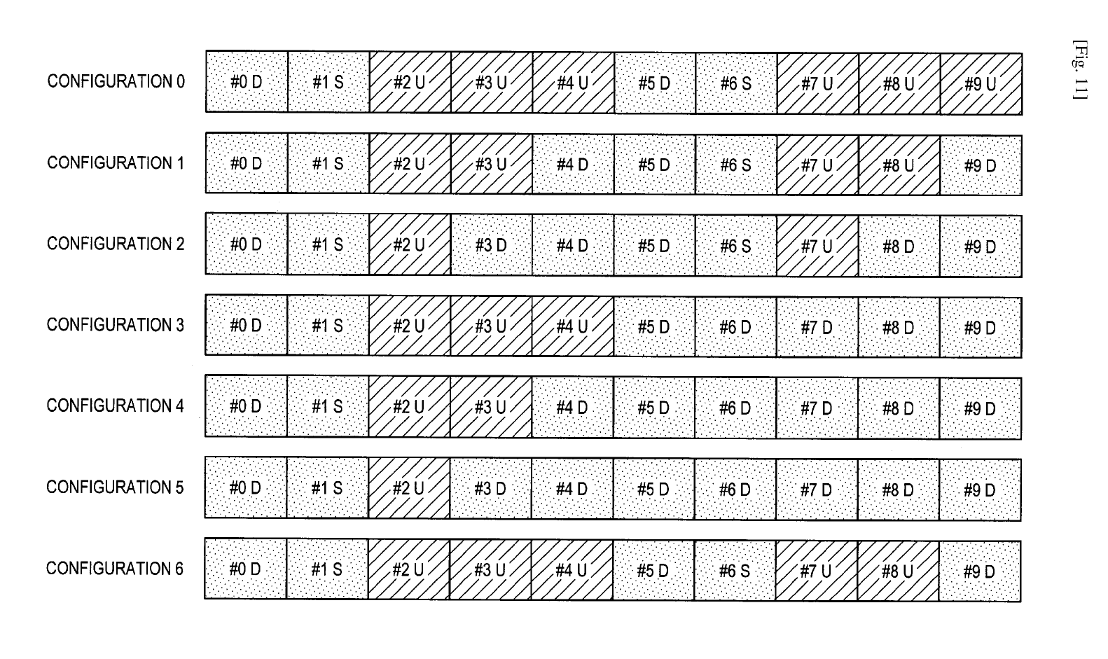

As the UL/DL configuration of the TDD, seven configurations are defined. Hereinafter, the seven configurations will be described with reference to FIG. 11.

FIG. 11 is an explanatory diagram for describing the UL/DL configuration of the TDD. Referring to FIG. 11, the seven UL/DL configurations (configurations 0 to 6) are illustrated. Each UL/DL configuration determines the uplink subframe and the downlink subframe among ten subframes included in the radio frame. Furthermore, each UL/DL configuration determines the special subframe among the ten subframes. Specifically, the subframes having subframe numbers of 0 and 5 are fixed to the downlink subframe in order to transmit the synchronization signal by the eNB. In addition, the subframe having a subframe number of 2 is fixed to the uplink subframe. Therefore, in all of the configurations, the subframe having a subframe number of 1 is the special subframe.

Further, the special subframe includes a downlink pilot time slot (DwPTS) of the downlink portion, an uplink pilot time slot (UpPTS) of the uplink portion, and a guard period (GP).

<1.2. Technical Problem>

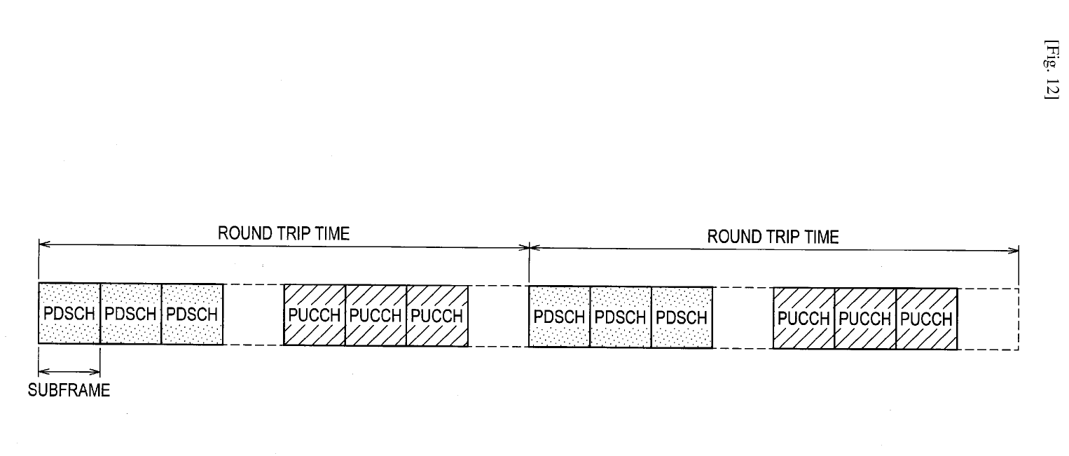

Next, a technical problem of an embodiment of the present disclosure will be described with reference to FIGS. 12 to 14.

(Basic Problem)

In NPL 1 “3GPP TSG RAN WG1 Meeting #76bis, Shenzhen, China, 31 Mar. to 4 Apr. 2014, CATT, “Number of HARQ processes for low complexity HD-FDD UEs”” and NPL 2 “3GPP TSG RAN WG1 Meeting #76bis, Shenzhen, P.R. China, 31 Mar. to 4 Apr. 2014, Ericsson, “Half duplex FDD for low cost MTC UE””, the number of HARQ processes required in the terminal device for performing the HD-FDD operation are proposed. Specifically, there is proposed a technology in which the number of HARQ processes of each of the uplink and the downlink is set to 3 on the existing assumption of the FDD in that the scheduling information of the uplink is transmitted or received in a subframe before four subframes compared to the transceiving of the uplink data, and the ACK/NACK is transmitted and received in a subframe after four subframes compared to the transceiving of the data.

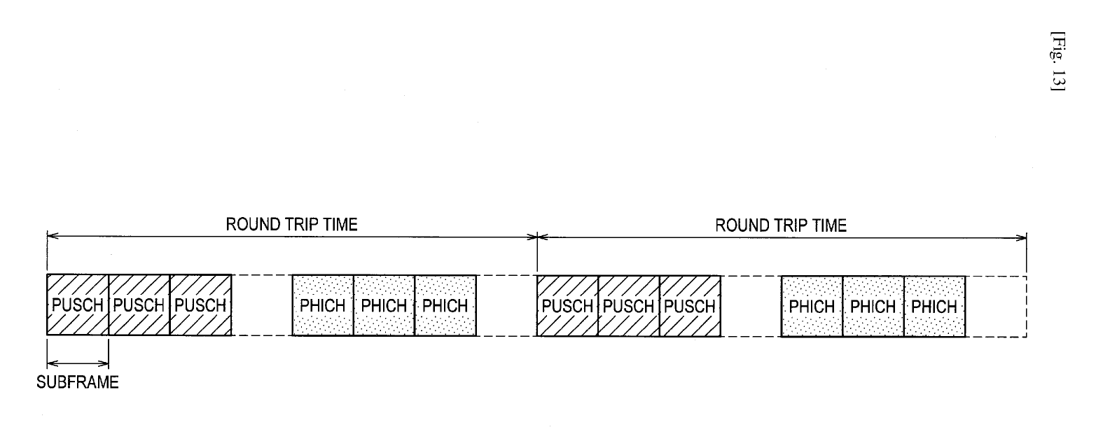

According to the technology disclosed in NPLs 1 and 2 described above, for example, three subframes among eight subframes are assigned to the downlink, and other three subframes among the eight subframes are assigned to the uplink Actually, such an assignment of the subframes to the downlink/uplink can be realized by the base station through the assignment of the radio resources (for example, a resource block). In addition, the subframes between the three subframes (the downlink) and the other three subframes (the uplink) are secured to be used for the switching between the transmission and the reception, and the radio resources of the subframes are not assigned to the terminal device which performs the switching. Hereinafter, a specific example of such a configuration will be described with reference to FIGS. 12 and 13.

FIG. 12 is an explanatory diagram for describing an example of the subframe in which the downlink data is transmitted and the subframe in which the ACK/NACK of the downlink data is transmitted. Referring to FIG. 12, the subframe in which the downlink data is transmitted by the eNB and the subframe in which the ACK/NACK of the downlink data is transmitted by the UE are illustrated. Specifically, the consecutive three subframes are assigned as the subframes in which the downlink data is transmitted by the PDSCH. One subframe after the consecutive three subframes is secured to be used for the switching between the downlink reception and the uplink transmission in the UE. The consecutive three subframes after the one subframe are assigned as the subframes in which the ACK/NACK of the downlink data is transmitted in the PUCCH. In other words, in the subframe after four subframes compared to the subframe in which the downlink data is transmitted by the eNB, the ACK/NACK of the downlink data can be transmitted by the UE. Furthermore, one subframe after the consecutive three subframes is secured to be used for the switching from the uplink transmission to the downlink reception in the UE. In this way, the downlink data and the ACK/NACK are transmitted in a round trip time of eight subframes.

FIG. 13 is an explanatory diagram for describing an example of the subframe in which the uplink data is transmitted and the subframe in which the ACK/NACK of the uplink data is transmitted. Referring to FIG. 13, the subframe in which the uplink data is transmitted by the UE and the subframe in which the ACK/NACK of the uplink data is transmitted by the eNB are illustrated. Specifically, the consecutive three subframes are assigned as the subframes in which the uplink data is transmitted by the PUSCH. One subframe after the consecutive three subframes is secured to be used for the switching from the uplink transmission to the downlink reception in the UE. The consecutive three subframes after the one subframe are assigned as the subframes in which the ACK/NACK of the uplink data is transmitted by a physical hybrid ARQ indicator channel (PHICH). In other words, the ACK/NACK of the downlink data can be transmitted by the eNB in a subframe after four subframes compared to the subframe in which the uplink data is transmitted by the UE. Furthermore, one subframe after the consecutive three subframes is secured to be used for the switching from the downlink reception to the uplink transmission in the UE. Therefore, the uplink data and the ACK/NACK are transmitted in the round trip time of eight subframes.

In a case where the terminal device supporting the TDD is positioned within a cell of the TDD, radio communication can be performed, but in a case where the terminal device supporting the TDD is positioned within the FDD for example, the radio communication is difficult to be performed. For example, the terminal device supporting the TDD necessarily performs the HD-FDD operation greatly different from a TDD operation as well as the switching of the frequency (of a local oscillator) in order to perform the HD-FDD operation as disclosed in the above non-patent literatures. Therefore, a process of the terminal device may become complicated.

Therefore, an embodiment of the present disclosure can make the radio communication easily performed in the cell of the FDD by the terminal device which supports the TDD.

(Another Problem)

(a) Assignment of Radio Resource

According to the technology disclosed in NPLs 1 and 2 described above, the subframe of the downlink and the subframe of the uplink are fixed. For example, depending on traffic, it may become difficult that the radio resource is flexibly assigned to the terminal device which performs the HD-FDD operation.

Therefore, an embodiment of the present disclosure, for example, can make the radio resource more flexibly assigned to the terminal device which performs the HD-FDD operation.

(b) Transmission of ACK/NACK

After the reception of the downlink data transmitted from the base station, the terminal device necessarily transmits the ACK/NACK of the downlink data to the base station. In addition, after the transmission of the uplink data to the base station, the terminal device necessarily receives the ACK/NACK of the uplink data from the base station.

However, the radio resource is freely assigned to the terminal device which performs the HD-FDD operation, and for example when the ACK/NACK of the data is transmitted after four subframes of the transceiving of the data as described in the existing assumption of the FDD, there is a possibility that the ACK/NACK is not appropriately transmitted or received.

Therefore, an embodiment of the present disclosure, for example, can further make the terminal device which performs the HD-FDD operation and the base station appropriately perform the transceiving of ACK/NACK.

(b) Case of Carrier Aggregation

In the carrier aggregation, the ACK/NACK of the downlink data transmitted by the secondary cell is transmitted is transmitted by the primary cell. Therefore, after the downlink data transmitted by the secondary cell is received, the terminal device necessarily transmits the ACK/NACK of the downlink data by the primary cell.

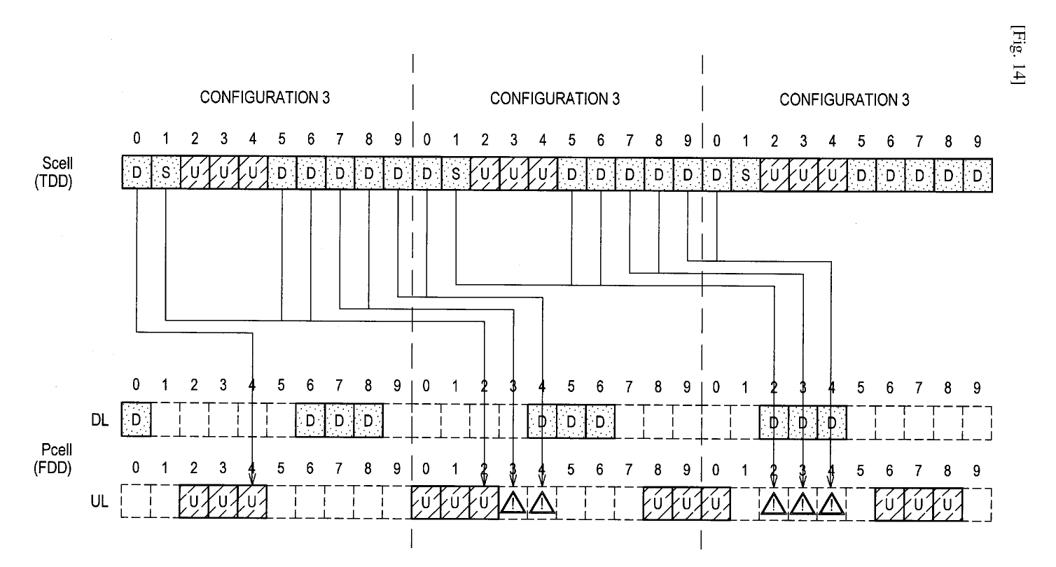

However, there is a possibility that the terminal device performs the downlink reception by the primary cell in the subframe in which the ACK/NACK of the downlink data transmitted by the secondary cell is transmitted. As a result, there is a concern that the ACK/NACK of the downlink data is not transmitted. Hereinafter, a specific example of such a configuration will be described with reference to FIG. 14.

FIG. 14 is an explanatory diagram for describing an example of the transmission of the ACK/NACK in the case of the carrier aggregation. Referring to FIG. 14, there is illustrated the state of the uplink and the downlink of the primary cell (Pcell) and the secondary cell (Scell) of the terminal device. In this example, the secondary cell is a component carrier (CC) of the TDD, and the primary cell is the CC of the FDD. For example, in the secondary cell, the transceiving of the uplink and the downlink is performed according to Configuration 3 defined in the 3GPP. On the other hand, in the primary cell, the transceiving of the uplink and the downlink is performed in the round trip time of eight subframes as described with reference to FIGS. 12 and 13. Herein, in the secondary cell, the terminal device transmits the ACK/NACK of the downlink data transmitted according to Configuration 3 in the ACK/NACK transmission subframe corresponding to Configuration 3. In other words, the terminal device transmits the ACK/NACK in the uplink subframe of Configuration 3. Furthermore, in the case of the carrier aggregation, the terminal device necessarily transmits the ACK/NACK by the primary cell. As an example, in the secondary cell, in a case where the downlink data is transmitted to the terminal device in the subframe having a subframe number of 9, the terminal device transmits the ACK/NACK of the downlink data in the next subframe having a subframe number of 4. In addition, the terminal device necessarily transmits the ACK/NACK in the primary cell. However, in the primary cell, the terminal device performs a downlink transmission in the next subframe having a subframe number of 4, so that the ACK/NACK of the downlink data is not possible to be transmitted.

Therefore, in a modification of the embodiment of the present disclosure, for example, the terminal device performing the HD-FDD operation and the base station can appropriately perform the transceiving of the ACK/NACK even in the case of the carrier aggregation.

<<2. Schematic Configuration of Communication System>>

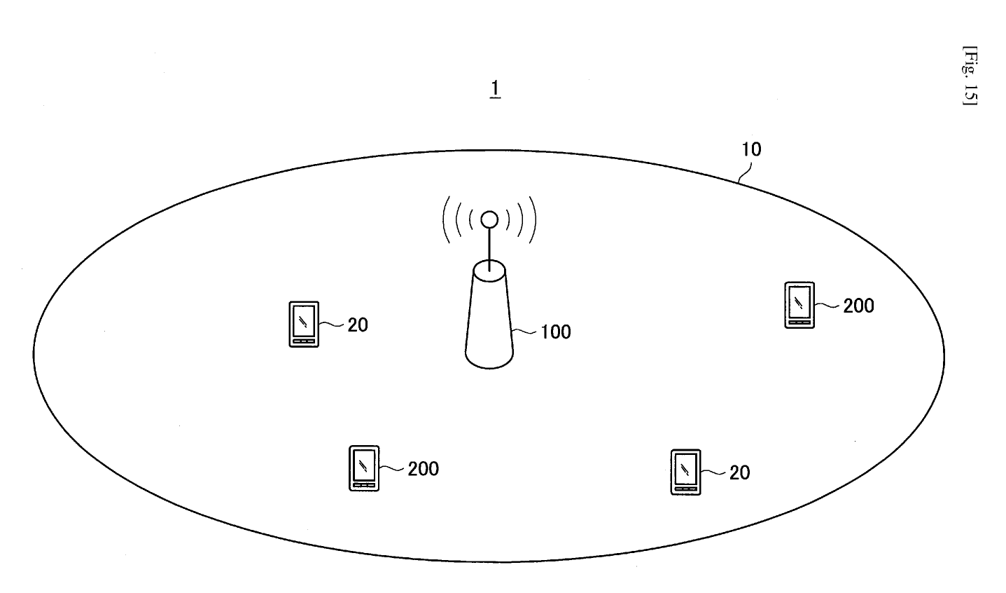

Then, a schematic configuration of a communication system 1 according to an embodiment of the present disclosure will be described with reference to FIG. 15. FIG. 15 is an explanatory diagram illustrating an example of a schematic configuration of the communication system 1 according to the embodiment of the present disclosure. Referring to FIG. 15, the communication system 1 includes a base station 100, a terminal device 20, and a terminal device 200. The communication system 1, for example, is a system in conformity to the LTE, the LTE-Advanced, or a standard based on these standards.

(Base Station 100)

The base station 100 is a base station of the cell 10. The cell 10 is a cell of the FDD, and the base station 100 performs the radio communication in the FDD. For example, the base station 100 transmits the downlink signal in the downlink bandwidth of the FDD, and receives an uplink signal in the uplink bandwidth of the FDD.

For example, the base station 100 performs the radio communication with the terminal device. The terminal device includes the terminal device 20 and the terminal device 200.

(Terminal Device 20)

The terminal device 20 performs the radio communication with the base station.

For example, the terminal device 20 supports the FDD, and performs the radio communication in the FDD. In other words, the terminal device 20 performs the radio communication with the base station (for example, the base station 100) of a cell of the FDD. Specifically, for example, the terminal device 20 supports the FD-FDD, and performs the radio communication in the FD-FDD. In other words, the terminal device 20 can simultaneously perform the downlink reception in the downlink bandwidth of the FDD and the uplink transmission in the uplink bandwidth of the FDD. For example, the terminal device 20 can perform both of the downlink reception and the uplink transmission in the same subframe.

(Terminal Device 200)

The terminal device 200 performs the radio communication with the base station.

For example, the terminal device 200 supports the TDD, and performs the radio communication in the TDD. In other words, the terminal device 200 performs the radio communication with the base station of a cell of the TDD. In other words, the terminal device 200 performs the uplink transmission in the frequency bandwidth of the TDD in a certain time, and performs the downlink reception in the subject frequency bandwidth in another time. For example, the terminal device 200 performs the uplink transmission in a certain subframe, and performs the downlink reception in another subframe.

Furthermore, for example, the terminal device 200 supports the FDD, and performs the radio communication in the FDD. In other words, the terminal device 200 performs the radio communication with the base station (for example, the base station 100) of a cell of the FDD. Specifically, for example, the terminal device 200 supports the HD-FDD, and performs the radio communication in the HD-FDD. In other words, the terminal device 200 performs the uplink transmission in the uplink bandwidth of the FDD in a certain time, and performs the downlink reception in the downlink bandwidth of the FDD in another time. For example, the terminal device 200 performs the uplink transmission in a certain subframe, and performs the downlink reception in another subframe.

Further, for example, the terminal device 200 does not support the FD-FDD, and not perform the radio communication in the FD-FDD.

(Macro Cell and Small Cell)

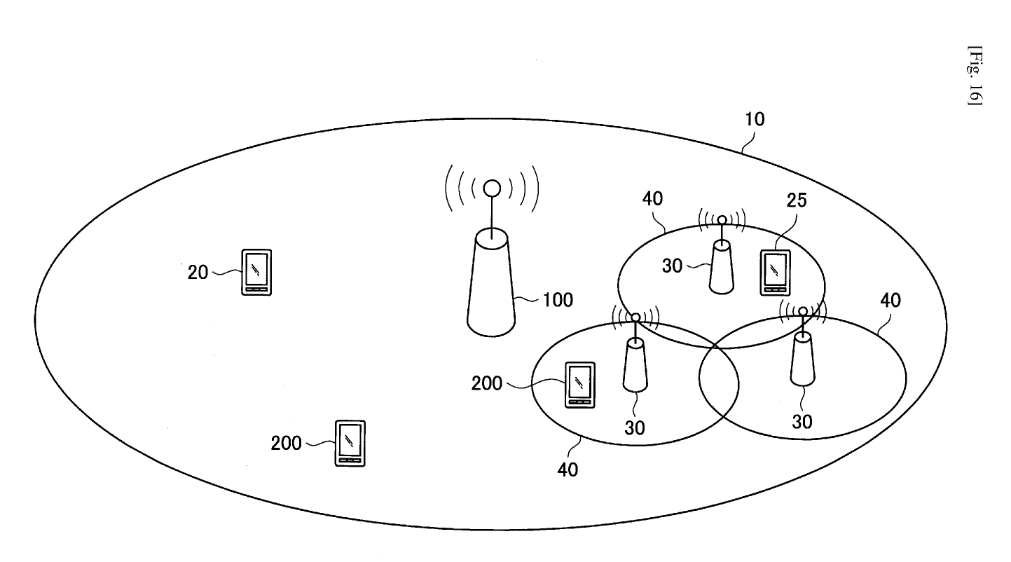

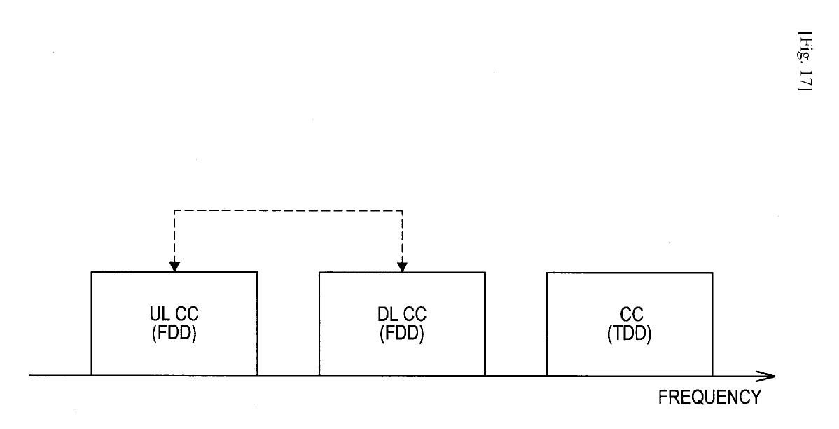

For example, the cell 10 is a macro cell in which small cells of the TDD are overlapped, and the base station 100 is a base station of the macro cell. Hereinafter, a specific example of such a configuration will be described with reference to FIGS. 16 and 17.

FIG. 16 is an explanatory diagram for describing an example in a case where the base station 100 is a base station of the macro cell. Referring to FIG. 16, the base station 100, the cell 10 of the base station 100, a base station 30, a cell 40 of the base station 30, the terminal device 20, a terminal device 25, and the terminal device 200 are illustrated. The cell 10 is a macro cell of the FDD, and the base station 100 is a base station of the macro cell. In addition, the cell 40 is a small cell of the TDD which is overlapped with the cell 10 (the macro cell), and the base station 30 is a base station of the small cell. For example, the terminal device 20 and the terminal device 200 perform the radio communication with the base station 100. The terminal device 25 which supports the terminal device 200 and the TDD performs the radio communication with the base station 30.

FIG. 17 is an explanatory diagram for describing the CC of the FDD and the CC of the TDD. Referring to FIG. 17, a pair of an uplink CC and a downlink CC of the FDD, and the CC of the TDD are illustrated. The base station 100 performs an uplink reception in the uplink CC, and performs the downlink transmission in the downlink CC. The base station 30 performs the uplink reception and the downlink transmission in the CC of the TDD.

### Feature of Embodiment of Present Disclosure

Particularly, in an embodiment of the present disclosure, the base station 100 notifies the UL/DL configuration of the TDD to the terminal device, and performs the radio communication in the HD-FDD with the terminal device 200 according to the UL/DL configuration.

In addition, particularly in the embodiment of the present disclosure, the terminal device 200 performs the radio communication in the HD-FDD with the base station 100 according to the UL/DL configuration notified to the terminal device 200 by the base station 100.

Therefore, for example, the terminal device 200 can more easily perform the radio communication in the cell of the FDD.

<<3. Configurations of Devices>>

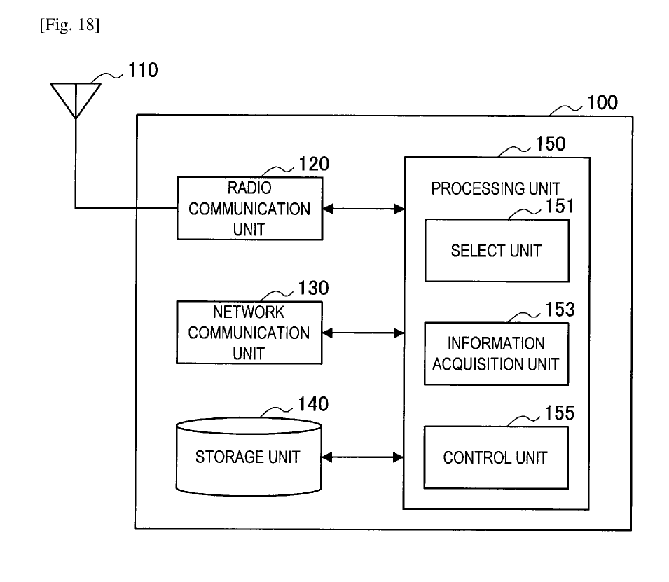

Then, an example of a configuration of the base station 100 and the terminal device 200 according to an embodiment of the present disclosure will be described with reference to FIGS. 18 to 24.

<3.1. Configuration of Base Station>

An example of a configuration of the base station 100 according to an embodiment of the present disclosure will be described with reference to FIGS. 18 to 22. FIG. 18 is a block diagram illustrating the example of the configuration of the base station 100 according to the embodiment of the present disclosure. Referring to FIG. 18, the base station 100 includes an antenna unit 110, a radio communication unit 120, a network communication unit 130, a storage unit 140, and a processing unit 150.

(Antenna Unit 110)

The antenna unit 110 radiates a signal output by the radio communication unit 120 into the space as an electric wave. In addition, the antenna unit 110 converts the electric wave in the space into a signal, and outputs the signal to the radio communication unit 120.

(Radio Communication Unit 120)

The radio communication unit 120 transmits and receives the signal. For example, the radio communication unit 120 transmits the downlink signal to the terminal device, and receives the uplink signal from the terminal device.

(Network Communication Unit 130)

The network communication unit 130 transmits and receives information. For example, the network communication unit 130 transmits information to another node, and receives information from the another node. For example, the another node includes a core network node and another base station.

(Storage Unit 140)

The storage unit 140 temporarily or permanently stores a program and data to operate an operation of the base station 100.

(Processing Unit 150)

The processing unit 150 provides various functions of the base station 100. The processing unit 150 includes a select unit 151, an information acquisition unit 153, and a control unit 155. Further, the processing unit 150 may further include other components besides these components. In other words, the processing unit 150 may perform other operations besides the operations of these components.

(Select Unit 151)

The select unit 151 selects the UL/DL configuration of the TDD.

(a) Selection among Plurality of UL/DL Configurations

For example, the select unit 151 selects a UL/DL configuration among a plurality of UL/DL configurations.

For example, the select unit 151 selects a UL/DL configuration among Configurations 0 to 6 illustrated in FIG. 11. Alternatively, the select unit 151 may select a UL/DL configuration among parts of Configurations 0 to 6 (for example, the configurations 3 to 5) illustrated in FIG. 11.

(b) Selection for Each Terminal Device

The select unit 151 individually selects the UL/DL configuration for the terminal device 200. In other words, the select unit 151 selects the UL/DL configuration for each terminal device 200.

For example, the select unit 151 selects the UL/DL configuration based on a traffic characteristic of the terminal device 200 for the terminal device 200. Specifically, for example, the select unit 151 selects a UL/DL configuration among the plurality of UL/DL configurations based on the traffic characteristic of the terminal device 200 for the terminal device 200. Further, the traffic characteristic, for example, is a traffic load in the past or at the present, or expected in a future.

Therefore, for example, the radio resource can be more flexibly assigned to each terminal device 200. For example, the radio resource can be flexibly assigned according to the traffic of the terminal device 200.

For example, the terminal device 200 of which the UL/DL configuration is selected is a device having a capability of performing the radio communication in the HD-FDD according to the UL/DL configuration of the TDD. For example, the terminal device 200 transmits the capability information indicating a capability of the terminal device 200 to the base station 100. The capability information indicates that the terminal device 200 is a device having the capability. As an example, the terminal device 200 transmits the UE capability information message to the base station 100. Then, the select unit 151 acquires the capability information, and selects the UL/DL configuration for the terminal device 200 having the capability. Therefore, for example, the base station 100 can specify the terminal device which performs the radio communication according to the UL/DL configuration.

Further, the select unit 151 may select a common UL/DL configuration among the terminal devices 200 instead of the selecting of the UL/DL configuration for each terminal device 200. As an example, the UL/DL configuration may be Configuration 3 illustrated in FIG. 11 regardless of the terminal device 200.

(Information Acquisition Unit 153)

The information acquisition unit 153 acquires information (hereinafter, referred to as “configuration information”) indicating the UL/DL configuration of the TDD.

(a) UL/DL Configuration

For example, the UL/DL configuration is a UL/DL configuration selected by the select unit 151. In other words, the information acquisition unit 153 acquires information indicating the selected UL/DL configuration.

(b) Configuration Information

For example, the configuration information is identification information of the UL/DL configuration. Specifically, for example, the identification information is assigned to each of the plurality of UL/DL configurations, and the configuration information is the identification information assigned to the UL/DL configuration (that is, the identification information of the UL/DL configuration). As an example, the configuration information is a configuration number.

(Control Unit 155)

(a) Notification of UL/DL configuration

The control unit 155 notifies the UL/DL configuration to the terminal device 200.

### (a-1) First Example: Individual Signaling

As a first example, the control unit 155 notifies the UL/DL configuration to the terminal device 200 by an individual signaling to the terminal device 200.

For example, the individual signaling is a radio resource control signaling (RRC). As an example, the individual signaling is a signaling performed during a procedure of establishing connection.

For example, the control unit 155 generates a message containing the configuration information (that is, the information indicating the UL/DL configuration), and transmits the message to the terminal device 200 through the antenna unit 110 and the radio communication unit 120.

Through the notification of the UL/DL configuration by the signaling, for example, the UL/DL configuration selected for each terminal device 200 can be notified to the terminal device 200.

Further, in the first example, the UL/DL configuration, for example, may be a UL/DL configuration (that is, a UL/DL configuration selected for each terminal device 200) individually selected for the terminal device 200, or may be a common UL/DL configuration among the terminal devices 200.

### (a-2) Second Example: Reporting of System Information

As a second example, the control unit 155 notifies the UL/DL configuration to the terminal device 200 by reporting system information indicating the UL/DL configuration.

For example, the control unit 155 generates the system information containing the configuration information, and reports the system information through the antenna unit 110 and the radio communication unit 120.

Further, in the second example, the UL/DL configuration is the common UL/DL configuration among the terminal devices 200.

Therefore, for example, the notification of the UL/DL configuration to the terminal device 200 can be made by the existing structure. In addition, the terminal device 200 can confirm that the radio communication in the HD-FDD can be performed according to the UL/DL configuration of the TDD in the cell 10.

As described above, the base station 100 (the control unit 155) notifies the UL/DL configuration to the terminal device 200. Therefore, for example, the radio resource can be more flexibly assigned to the terminal device 200. More specifically, for example, the base station 100 flexibly selects the UL/DL configuration, and can share the UL/DL configuration with the terminal device 200. Therefore, the radio resource is assigned to the terminal device 200 according to the UL/DL configuration flexibly selected. In other words, the radio resource can be flexibly assigned to the terminal device 200.

(b) Control of Radio Communication according to UL/DL Configuration

For example, the control unit 155 controls the radio communication with the terminal device 200 in the HD-FDD according to the UL/DL configuration.

Therefore, for example, the terminal device 200 can more flexibly perform the radio communication in the cell of the FDD. More specifically, for example, the HD-FDD operation according to the UL/DL configuration of the TDD is overlapped with many parts of the operation of the TDD. Therefore, the process of the terminal device 200 can be avoided from being complicated.

In addition, in the UL/DL configuration of the TDD, a subframe (that is, a subframe having a subframe number of 0) in which a physical broadcast channel (PBCH) is disposed is typically the downlink subframe. Therefore, the terminal device 200 can securely receive the system information (that is, MIB) transmitted by the PBCH.

### (b-1) Assignment of Radio Resource (Scheduling)

For example, the control unit 155 assigns the radio resource to the terminal device 200 according to the UL/DL configuration. The radio resource includes the radio resource of the uplink bandwidth and the radio resource of the downlink bandwidth.

Specific Subframe

For example, the control unit 155 does not assign the radio resources of two or more specific subframes between one uplink subframe and one downlink subframe of the UL/DL configuration to the terminal device 200.

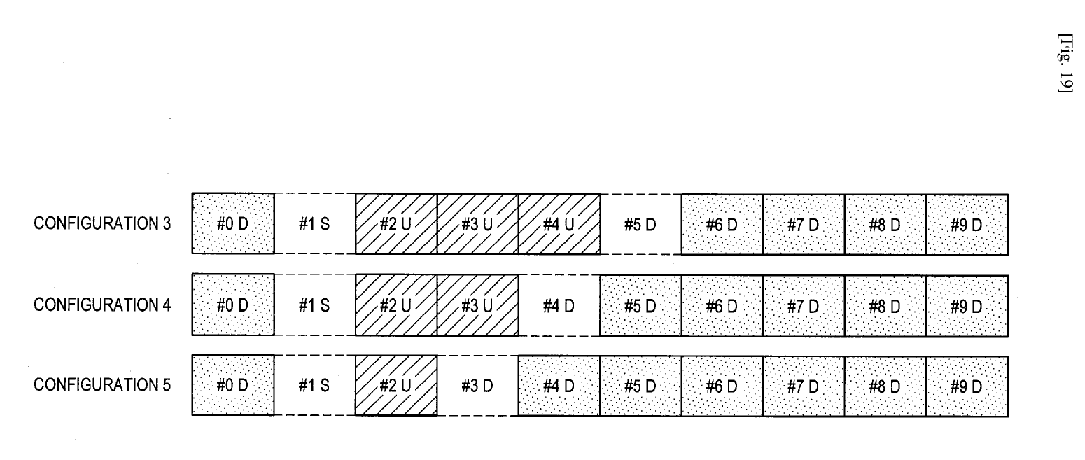

For example, the two or more specific subframes include one or more special subframes, one or more subframes (the uplink subframes or the downlink subframes) immediately after one uplink subframe and immediately before one downlink subframe. Hereinafter, a specific example of such a configuration will be described with reference to FIG. 19.

FIG. 19 is an explanatory diagram for describing an example of assigning the radio resources to the terminal device 200. Referring to FIG. 19, Configurations 3 to 5 defined in the 3GPP are illustrated. For example, in a case where the UL/DL configuration is Configuration 3, the control unit 155 does not assign the radio resource of the special subframe having a subframe number of 1 and the radio resource of the downlink subframe having a subframe number of 5 to the terminal device 200. For example, in a case where the UL/DL configuration is Configuration 4, the control unit 155 does not assign the radio resource of the special subframe having a subframe number of 1 and the radio resource of the downlink subframe having a subframe number of 4 to the terminal device 200. For example, in a case where the UL/DL configuration is Configuration 5, the control unit 155 does not assign the radio resource of the special subframe having a subframe number of 1 and the radio resource of the downlink subframe having a subframe number of 3 to the terminal device 200.

Therefore, for example, the terminal device 200 can perform switching between the uplink transmission and the downlink reception.

Another Subframe

For example, the control unit 155 assigns the radio resource of another subframe different from the two specific subframes to the terminal device 200.

For example, the another subframe includes the uplink subframe and/or the downlink subframe of the UL/DL configuration.

Uplink Subframe

For example, the radio resource of the another subframe includes the radio resource of the uplink subframe of the UL/DL configuration among the radio resources of the uplink bandwidth. In other words, the control unit 155 assigns the radio resource of the uplink subframe of the UL/DL configuration among the radio resources of the uplink bandwidth to the terminal device 200.

For example, the assigned radio resource is a resource block. More specifically, for example, the assigned radio resource is a resource block of a physical uplink shared channel (PUSCH).

Downlink Subframe

For example, the radio resource of the another subframe includes the radio resource of the downlink subframe of the UL/DL configuration among the radio resources of the downlink bandwidth. In other words, the control unit 155 assigns the radio resource of the downlink subframe of the UL/DL configuration among the radio resources of the downlink bandwidth to the terminal device 200.

For example, the assigned radio resource is a resource block. More specifically, for example, the assigned radio resource is a resource block of a physical downlink shared channel (PDSCH).

### (b-2) Notification of Assignment of Radio Resource

For example, the control unit 155 notifies the terminal device 200 about the assignment to the terminal device 200 of the radio resource.

Specifically, for example, the control unit 155 generates scheduling information indicating the assignment to the terminal device 200 of the radio resource, maps the signal of the scheduling information to a control channel (for example, a physical downlink control channel).

Further, the control unit 155 notifies the terminal device 200 about the assignment to the terminal device 200 of the radio resource of the uplink subframe of the UL/DL configuration in a predetermined downlink subframe for the UL/DL configuration. Therefore, for example, similarly to the case of the TDD, the terminal device 200 can obtain the scheduling information of the uplink. The downlink subframe, for example, is defined in Table 8-2 of 3GPP TS36.213.

### (b-3) Execution of Retransmission Request Process

For example, the control unit 155 performs a retransmission request process to transmit the ACK/NACK of the uplink data transmitted from the terminal device 200 according to the UL/DL configuration toward the terminal device 200 in the downlink subframe of the UL/DL configuration. Therefore, for example, the terminal device 200 can receive the ACK/NACK of the uplink data.

For example, the retransmission request process is an HARQ process.

### First Example: Predetermined Subframe for Configuration

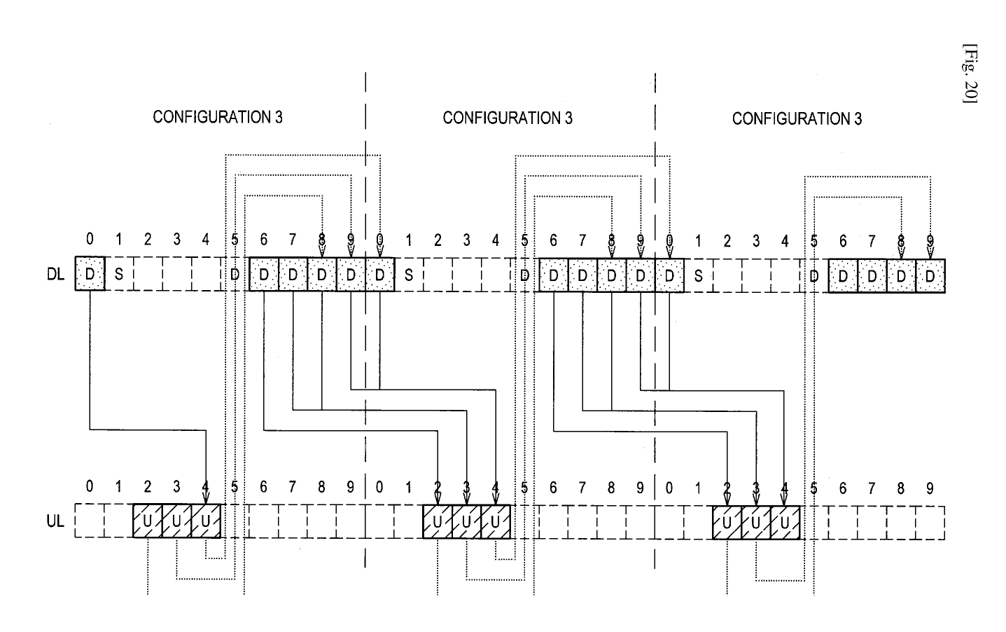

As a first example, the control unit 155 performs the retransmission request process to transmit the ACK/NACK of the uplink data to the terminal device 200 in an ACK/NACK transmission downlink subframe which is predetermined for the UL/DL configuration. Hereinafter, a specific example of such a configuration will be described with reference to FIGS. 20 to 22.

Configuration 3

FIG. 20 is an explanatory diagram for describing a first example of the ACK/NACK transmission subframe which is predetermined for the UL/DL configuration. In this example, the terminal device 200 performs the radio communication in the HD-FDD according to Configuration 3 among the UL/DL configurations of the TDD. In this case, the base station 100 and the terminal device 200 transmit and receive the ACK/NACK in the ACK/NACK transmission subframe which is predetermined for Configuration 3.

Specifically, the ACK/NACK of the uplink data transmitted in the uplink subframe having a subframe number of 2 is transmitted in the downlink subframe having a subframe number of 8. The ACK/NACK of the uplink data transmitted in the uplink subframe having a subframe number of 3 is transmitted in the downlink subframe having a subframe number of 9. The ACK/NACK of the uplink data transmitted in the uplink subframe having a subframe number of 4 is transmitted in the downlink subframe having a subframe number of 0.

Specifically, the ACK/NACK of the downlink data transmitted in the downlink subframe having a subframe number of 6 is transmitted in the uplink subframe having a subframe number of 2. The ACK/NACK of the downlink data transmitted in the downlink subframe having a subframe number of 7 or 8 is transmitted in the uplink subframe having a subframe number of 3. The ACK/NACK of the downlink data transmitted in the downlink subframe having a subframe number of 9 or 0 is transmitted in the uplink subframe having a subframe number of 4.

Configuration 4

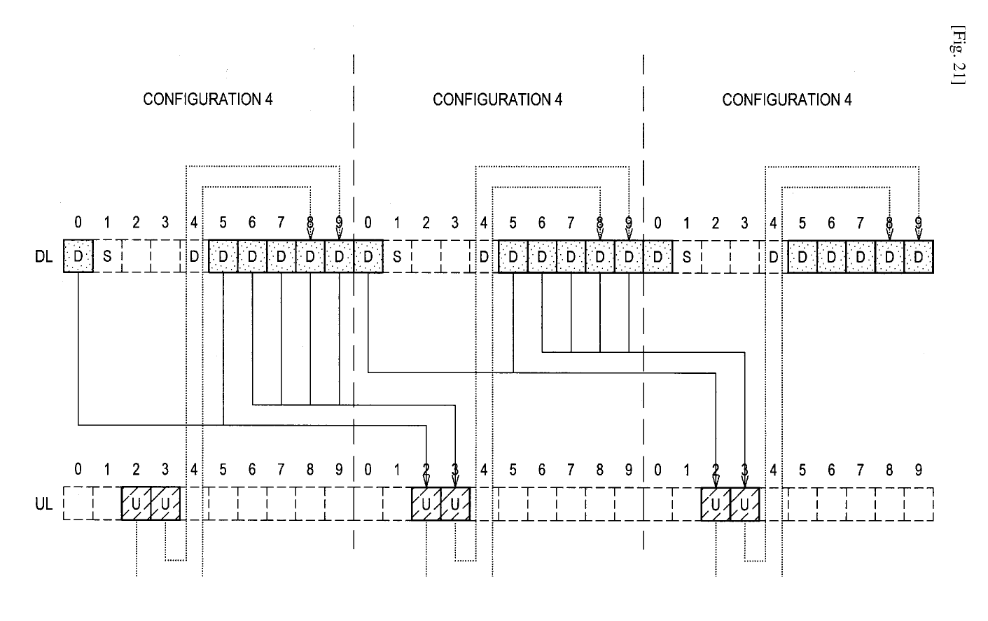

FIG. 21 is an explanatory diagram for describing a second example of the ACK/NACK transmission downlink subframe which is predetermined for the UL/DL configuration. In this example, the terminal device 200 performs the radio communication in the HD-FDD according to Configuration 4 among the UL/DL configurations of the TDD. In this case, the base station 100 and the terminal device 200 transmit and receive the ACK/NACK in the ACK/NACK transmission subframe which is predetermined for Configuration 4.

Specifically, the ACK/NACK of the uplink data transmitted in the uplink subframe having a subframe number of 2 is transmitted in the downlink subframe having a subframe number of 8. The ACK/NACK of the uplink data transmitted in the uplink subframe having a subframe number of 3 is transmitted in the downlink subframe having a subframe number of 9.

Specifically, the ACK/NACK of the downlink data transmitted in the downlink subframe having a subframe number of 0 or 5 is transmitted in the uplink subframe having a subframe number of 2. The ACK/NACK of the downlink data transmitted in the downlink subframe having a subframe number of any of 6 to 9 is transmitted in the uplink subframe having a subframe number of 3.

Configuration 5

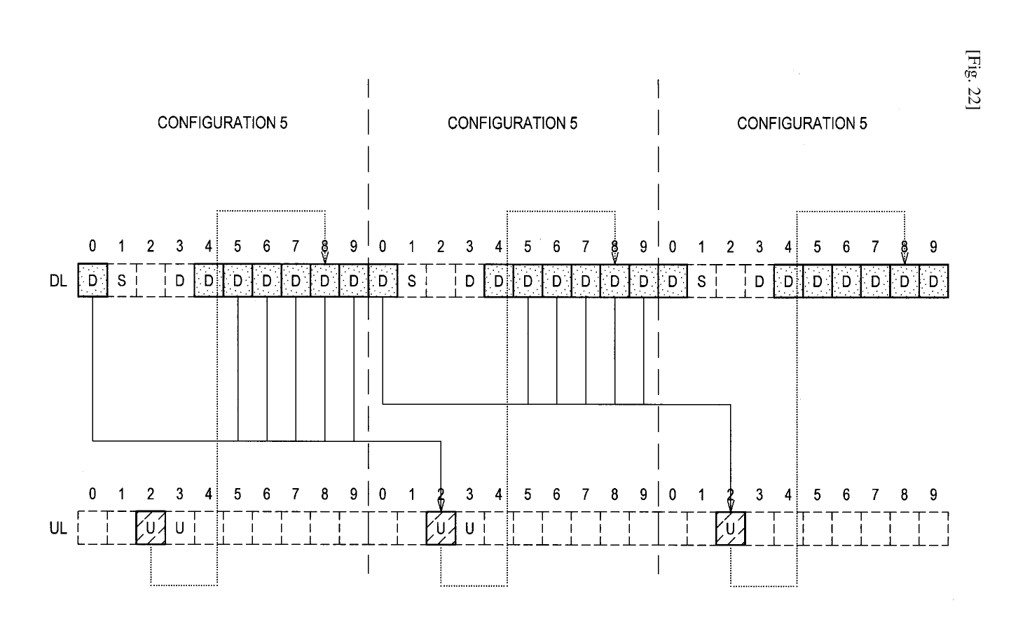

FIG. 22 is an explanatory diagram for describing a third example of the ACK/NACK transmission downlink subframe which is predetermined for the UL/DL configuration. In this example, the terminal device 200 performs the radio communication in the HD-FDD according to Configuration 5 among the UL/DL configurations of the TDD. In this case, the base station 100 and the terminal device 200 transmit and receive the ACK/NACK in the ACK/NACK transmission subframe which is predetermined for Configuration 5.

Specifically, the ACK/NACK of the uplink data transmitted in the uplink subframe having a subframe number of 2 is transmitted in the downlink subframe having a subframe number of 8.

Specifically, the ACK/NACK of the downlink data transmitted in all the downlink subframes is transmitted in the uplink subframe having a subframe number of 2.

For example, as described above, the ACK/NACK of the uplink data is transmitted to the terminal device 200 in the ACK/NACK transmission downlink subframe which is predetermined for the UL/DL configuration. Therefore, for example, the ACK/NACK is transmitted in the subframe suitable for each UL/DL configuration.

### Second Example: Common Subframe Among Configurations

For example, as described above, the UL/DL configuration is a UL/DL configuration selected among the plurality of UL/DL configurations. In this case, as a second example, the control unit 155 may perform the retransmission request process such that the ACK/NACK of the uplink data is transmitted to the terminal device 200 through a common subframe among the plurality of UL/DL configurations.

As an example, even in a case where any one of Configurations 0 to 6 illustrated in

FIG. 11 is selected as the UL/DL configuration, the ACK/NACK of the uplink data may be transmitted through at least one of the downlink subframes having subframe numbers of 0 and 5.

Therefore, for example, even in a case where the UL/DL configuration is dynamically changed, the terminal device 200 can receive the ACK/NACK of the uplink data.

<3.2. Configuration of Terminal Device>

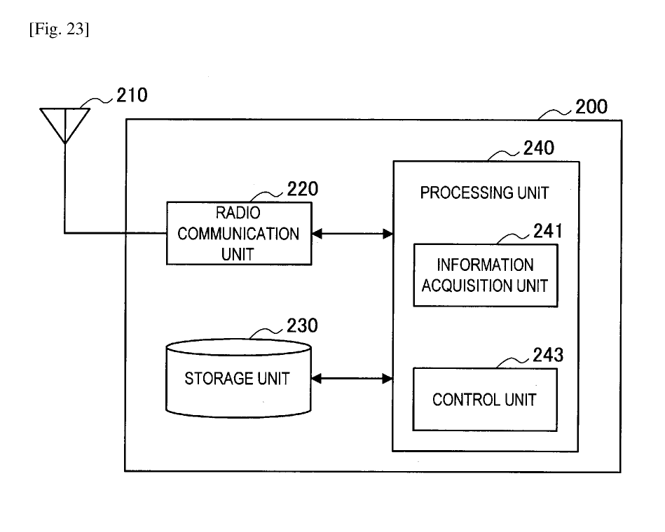

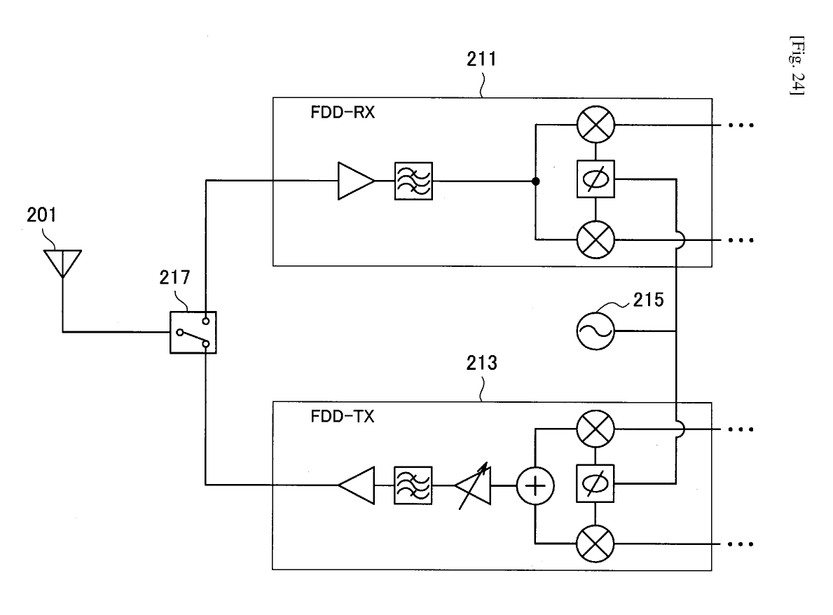

An example of the configuration of the terminal device 200 according to an embodiment of the present disclosure will be described with reference to FIGS. 23 and 24. FIG. 23 is a block diagram illustrating an example of the configuration of the terminal device 200 according to an embodiment of the present disclosure. Referring to FIG. 23, the terminal device 200 includes an antenna unit 210, a radio communication unit 220, a storage unit 230, and a processing unit 240.

(Antenna Unit 210)

The antenna unit 210 radiates a signal output by the radio communication unit 220 into the space as an electric wave. In addition, the antenna unit 210 converts the electric wave in the space into a signal, and outputs the signal to the radio communication unit 220.

(Radio Communication Unit 220)

The radio communication unit 220 transmits and receives a signal. For example, the radio communication unit 220 receives the downlink signal from the base station, and transmits the uplink signal to the base station. Further, the radio communication unit 220 does not simultaneously perform the reception of the downlink signal and the transmission of the uplink signal. Hereinafter, an example of hardware which is included in the radio communication unit 220 will be described with reference to FIG. 24.

FIG. 24 is an explanatory diagram for describing an example of hardware which is included in the radio communication unit 220 of the terminal device 200 according to an embodiment of the present disclosure. Referring to FIG. 24, there are illustrated an antenna 201 included in the antenna unit 210, an FDD receiving circuit 211 included in the radio communication unit 220, an FDD receiving circuit 213, a local oscillator 215, and a switch 217.

For example, the terminal device 200 performs the radio communication in the TDD. In this case, the frequency of the local oscillator 215 is set to a frequency of the frequency bandwidth of the TDD. In addition, in a case where the terminal device 200 receives the downlink signal, the switch 217 connects the antenna 201 to the FDD receiving circuit 211, and in a case where the terminal device 200 transmits the uplink signal, the switch 217 connects the antenna 201 to the FDD receiving circuit 213.

For example, the terminal device 200 performs the radio communication in the HD-FDD. In this case, in a case where the terminal device 200 receives the downlink signal, the frequency of the local oscillator 215 is set to a frequency of the downlink bandwidth, and the switch 217 connects the antenna 201 to the FDD receiving circuit 211. In a case where the terminal device 200 transmits the uplink signal, the frequency of the local oscillator 215 is set to a frequency of the uplink bandwidth, and the switch 217 connects the antenna 201 to the FDD receiving circuit 213.

(Storage Unit 230)

The storage unit 230 temporarily or permanently stores a program and data to operate an operation of the terminal device 200.

(Processing Unit 240)

The processing unit 240 provides various functions of the terminal device 200. The processing unit 240 includes an information acquisition unit 241 and a control unit 243. Further, the processing unit 240 may further include other components besides these components. In other words, the processing unit 240 may perform other operations besides the operations of these components.

(Information Acquisition Unit 241)

The information acquisition unit 241 acquires information indicating the UL/DL configuration of the TDD which is notified by the base station 100 to the terminal device 200.

For example, as described above, the base station 100 notifies the UL/DL configuration to the terminal device 200. Then, the information indicating the UL/DL configuration is stored in the storage unit 230. At any timing thereafter, the information acquisition unit 241 acquires the information indicating the UL/DL configuration from the storage unit 230.

(Control Unit 243)

(a) Control of Radio Communication according to UL/DL Configuration

The control unit 243 controls the radio communication in the HD-FDD with respect to the base station 100 by the terminal device 200 according to the UL/DL configuration.

Therefore, for example, the terminal device 200 can more easily perform the radio communication in the cell of the FDD. In addition, the radio resource can be more flexibly assigned to the terminal device 200 which performs the radio communication in the HD-FDD.

(a-1) Switching between Transmission and Reception in Specific Subframe

For example, the control unit 243 performs switching between the downlink reception and the uplink transmission by the terminal device 200 in two or more specific subframes which are located between one uplink subframe and one downlink subframe of the UL/DL configuration.

Examples of Specific Subframes

For example, the two or more specific subframes include one or more special subframes, one or more subframes (the uplink subframes or the downlink subframes) immediately after one uplink subframe and immediately before one downlink subframe.

Referring to FIG. 19 again, for example, in a case where the UL/DL configuration is Configuration 3, the control unit 243 performs the switching between the downlink reception and the uplink transmission in the special subframe having a subframe number of 1 and the downlink subframe having a subframe number of 5. For example, in a case where the UL/DL configuration is Configuration 4, the control unit 243 performs the switching between the downlink reception and the uplink transmission in the special subframe having a subframe number of 1 and the downlink subframe having a subframe number of 4. For example, in a case where the UL/DL configuration is Configuration 5, the control unit 243 performs the switching between the downlink reception and the uplink transmission in the special subframe having a subframe number of 1 and the downlink subframe having a subframe number of 3.

Switching

For example, the control unit 243 performs the switching under control of the radio communication unit 220. Referring to FIG. 24 again, for example, the control unit 243 performs the switching by instructing a change of a frequency of the local oscillator 215 and a connection destination of the switch 217 (for example, to the radio communication unit 220).

For example, the control unit 243 instructs the radio communication unit 120 to change the frequency of the local oscillator 215 from a frequency of the downlink bandwidth to a frequency of the uplink bandwidth, and change the connection destination of the switch 217 from the FDD receiving circuit 211 to the FDD receiving circuit 213. Therefore, the radio communication of the terminal device 200 is switched from the downlink reception to the uplink transmission.

For example, the control unit 243 instructs the radio communication unit 120 to change the frequency of the local oscillator 215 from a frequency of the uplink bandwidth to a frequency of the downlink bandwidth, and change the connection destination of the switch 217 from the FDD receiving circuit 213 to the FDD receiving circuit 211. Therefore, the radio communication of the terminal device 200 is switched from the uplink transmission to the downlink reception.

As described above, the switching between the downlink reception and the uplink transmission is performed by the terminal device 200 in the two or more specific subframes. Therefore, for example, the terminal device 200 can actually perform the radio communication according to the UL/DL configuration.

(a-2) Transmission and Reception in Another Subframe

For example, the control unit 243 controls the radio communication in the HD-FDD with respect to the base station 100 by the terminal device 200 such that the terminal device 200 performs the downlink reception or the uplink transmission in another subframe different from the two or more specific subframe.

Downlink Subframe

For example, the control unit 243 controls the radio communication using the terminal device 200 such that the terminal device 200 performs the downlink reception of the downlink bandwidth in the downlink subframe of the UL/DL configuration different from the two or more specific subframes.

For example, the control unit 243 checks whether the radio resource is assigned to the terminal device 200 from the scheduling information transmitted through the control channel (for example, the PDCCH) of the downlink bandwidth in the downlink subframe of the UL/DL configuration.

For example, in a case where the radio resource (the radio resource of the downlink bandwidth) of the downlink subframe is assigned to the terminal device 200, the control unit 243 performs the reception process (for example, demodulation, decoding, etc.) of the downlink signal transmitted in the radio resource.

For example, in a case where the radio resource (the radio resource of the uplink bandwidth) of the uplink subframe is assigned to the terminal device 200, the control unit 243 stores the scheduling information indicating the assignment of the radio resource to the terminal device 200 in the storage unit 230.

Uplink Subframe

For example, the control unit 243 controls the radio communication using the terminal device 200 such that the terminal device 200 performs the uplink transmission of the uplink bandwidth in the uplink subframe of the UL/DL configuration different from the two or more specific subframes.

For example, in a case where the uplink subframe (the radio resource of the uplink bandwidth) is assigned to the terminal device 200, the control unit 243 performs a process of transmitting (for example, mapping of the uplink signal to the radio resource) of the uplink signal in the radio resource.

(a-3) Execution of Retransmission Request Process

For example, the control unit 243 performs a retransmission request process to transmit the ACK/NACK of the downlink data transmitted from the base station 100 according to the UL/DL configuration toward the base station 100 in the uplink subframe of the UL/DL configuration. Therefore, for example, the base station 100 can receive the ACK/NACK of the downlink data.

For example, the retransmission request process is an HARQ process.

### First Example: Predetermined Subframe for Configuration

As a first example, the control unit 243 performs the retransmission request process to transmit the ACK/NACK of the uplink data to the terminal device 200 in an ACK/NACK transmission downlink subframe which is predetermined for the UL/DL configuration.

For example, as described above with reference to FIGS. 20 to 22, the ACK/NACK of the downlink data transmitted from the base station 100 is transmitted in the uplink subframe.

Therefore, for example, the ACK/NACK is transmitted in the subframe suitable for each UL/DL configuration.

### Second Example: Common Subframe Among Configurations

For example, as described above, the UL/DL configuration is a UL/DL configuration selected among the plurality of UL/DL configurations. In this case, as a second example, the control unit 243 may perform the retransmission request process such that the ACK/NACK of the uplink data is transmitted to the base station 100 through a common subframe among the plurality of UL/DL configurations.

As an example, even in a case where any one of Configurations 0 to 6 illustrated in

FIG. 11 is selected as the UL/DL configuration, the ACK/NACK of the downlink data may be transmitted through the uplink subframe having a subframe number of 2.

Therefore, for example, even in a case where the UL/DL configuration is dynamically changed, the terminal device 200 can transmit the ACK/NACK of the downlink data.

(b) Notification of Capability

For example, the control unit 243 notifies the base station 100 about that the terminal device 200 is a device having a capability of performing the radio communication in the HD-FDD according to the UL/DL configuration of the TDD.

Specifically, for example, the control unit 243 transmits the UE capability information message indicating that the terminal device 200 has the above capability to the base station 100 through the antenna unit 210 and the radio communication unit 220.

Therefore, for example, the base station 100 can specify the terminal device 200 as a terminal device to perform the radio communication according to the UL/DL configuration.

<<5. Flow of Process>>

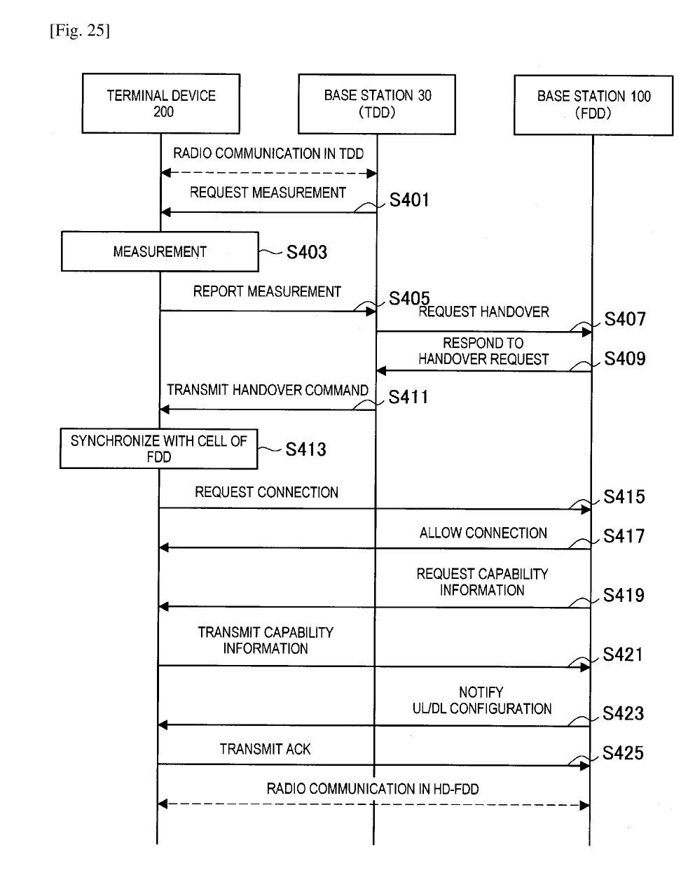

Then, an example of a process of the base station 100 and the terminal device 200 according to an embodiment of the present disclosure will be described with reference to FIGS. 25 to 27.

(Process of Base Station 100 and Terminal Device 200)

FIG. 25 is a sequence diagram illustrating an example of a schematic flow of a process of the base station 100 and the terminal device 200 according to an embodiment of the present disclosure. The process is a process performed in a case where the terminal device 200 is handed over from the base station 30 to the base station 100 (that is, a handover of the terminal device 200 from the cell 40 of the TDD to the cell 10 of the FDD).

The terminal device 200 and the base station 30 perform the radio communication in the TDD. In the terminal device 200, when signal strength of the cell 40 is weak, the base station 30 requests a measurement of a peripheral cell from the terminal device 200 (S401).

The terminal device 200 performs the measurement of the peripheral cell in response to the request from the base station 30 (S403). The measurement includes not only a measurement on the cell of the TDD but also a measurement on the cell of the FDD. The terminal device 200 holds a list of frequencies which are targets of the cell search in advance. Thereafter, the terminal device 200 transmits a report on the measurement to the base station 30 (S405).

The base station 30 determines a handover of the terminal device 200 from the base station 30 to the base station 100, and requests the handover from the base station 100 (S407). Then, the base station 100 transmits an acknowledgement to the base station 30 in response to the request for the handover (S409), and the base station 30 transmits a handover command to the terminal device 200 (S411).

The terminal device 200 is synchronized with the cell 10 of the base station 100 (S413), and requests a connection to the base station 100 (S415). Then, the base station 100 allows the connection (S417).

The base station 100 requests the capability information indicating a capability of the terminal device 200 from the terminal device 200 (S419), and the terminal device 200 transmits the capability information to the base station 100 (S421).

The base station 100 can notify the terminal device 200 of the UL/DL configuration for the terminal device 200 (S423). Then, the terminal device 200 can transmit an acknowledgement to the base station 100 (S425).

Thereafter, the terminal device 200 and the base station 100 perform the radio communication in the HD-FDD according to the UL/DL configuration (which is included in the system information or individually notified to the terminal device 200).

(Process of Terminal Device 200)

(a) First Process

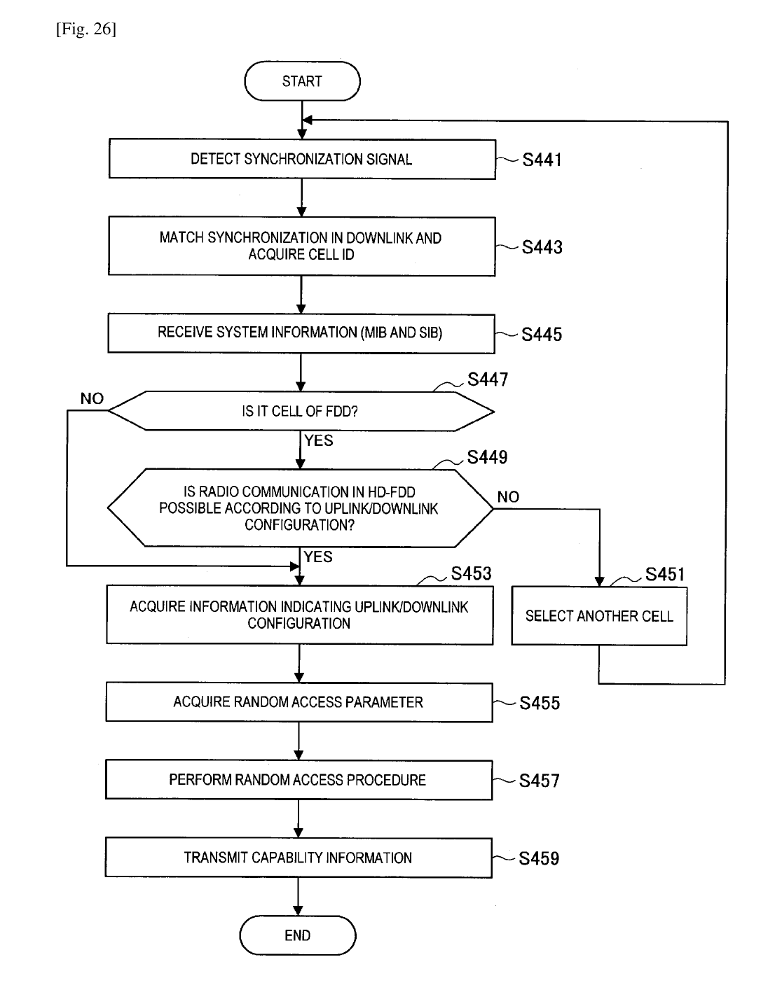

FIG. 26 is a flowchart illustrating an example of a schematic flow of a first process of the terminal device 200 according to an embodiment of the present disclosure. The first process is a process from the cell search to the transmission of the capability information.

The terminal device 200 holds a list of frequencies which are targets of the cell search in advance. Therefore, the terminal device 200 receives the downlink signal according to the list and detects the synchronization signal contained in the received downlink signal (S441). For example, the synchronization signal includes the PSS and the SSS. The terminal device 200 matches synchronization in the downlink based on the synchronization signal, and acquires the cell ID (S443).

Furthermore, the terminal device 200 receives the system information (S445). The system information is the MIB and the SIB.

Since the cell of the TDD and the cell of the FDD are different from each other in locations of a time domain in which the synchronization signal is transmitted, the terminal device 200 can determine whether the target cell is a cell of the TDD or a cell of the FDD by detecting the synchronization signal (S447). In addition, in a case where the target cell is a cell of the FDD (YES in S447), the terminal device 200, for example, can make a determination on the target cell about that the radio communication in the HD-FDD according to the UL/DL configuration is possible based on a determination on whether the UL/DL configuration of the TDD is included in the system information (S449). Further, since the standard of a pair of the downlink bandwidth and the uplink bandwidth of the FDD is determined in advance, the terminal device 200 can confirm the uplink bandwidth of the FDD by checking the downlink bandwidth of the FDD.

For example, the target cell is a cell of the FDD (YES in S447), and the radio communication in the HD-FDD is not possible in the target cell according to the UL/DL configuration (NO in S449). In this case, the terminal device 200 selects another cell (S451). Then, the process returns to Step S441.

For example, the target cell is a cell of the FDD (YES in S447), and the radio communication in the HD-FDD is possible in the target cell according to the UL/DL configuration (YES in S449). In this case, the terminal device 200 acquires information indicating the UL/DL configuration from the system information (S453), and acquires a random access parameter (S455). Then, the terminal device 200 performs a random access procedure (and a connection procedure) (S457). Furthermore, the terminal device 200 transmits the capability information indicating a capability of the terminal device 200 to the base station 100 in response to a request from the base station 100 (S459). For example, the capability information is the UE capability information message. Through the transmission of the capability information, the terminal device 200 notifies the base station 100 about that the terminal device 200 supports the HD (the HD-FDD). In addition, through the transmission of the capability information, the terminal device 200 notifies the base station 100 about that the terminal device 200 is a device having a capability of performing the radio communication in the HD-FDD according to the UL/DL configuration. Then, the process is ended.

Further, after the process is ended, the terminal device 200 (the information acquisition unit 241) acquires the information indicating the UL/DL configuration. Then, the terminal device 200 (the control unit 243) performs the radio communication n the HD-FDD according to the UL/DL configuration. In addition, the base station 100 can further notify the UL/DL configuration individually selected for the terminal device 200 to the terminal device 200. In this case, the terminal device 200 performs the radio communication in the HD-FDD according to the UL/DL configuration individually selected for the terminal device 200.

On the other hand, in a case where the target cell is a cell of the TDD (NO in S447), the terminal device 200 acquires the information indicating the UL/DL configuration from the system information (S453), and acquires the random access parameter (S455). Then, the terminal device 200 performs the random access procedure (and the connection procedure) (S457). Furthermore, the terminal device 200 transmits the capability information indicating a capability of the terminal device 200 to the base station 100 in response to the request from the base station 100 (S459). Then, the process is ended.

(b) Second Process

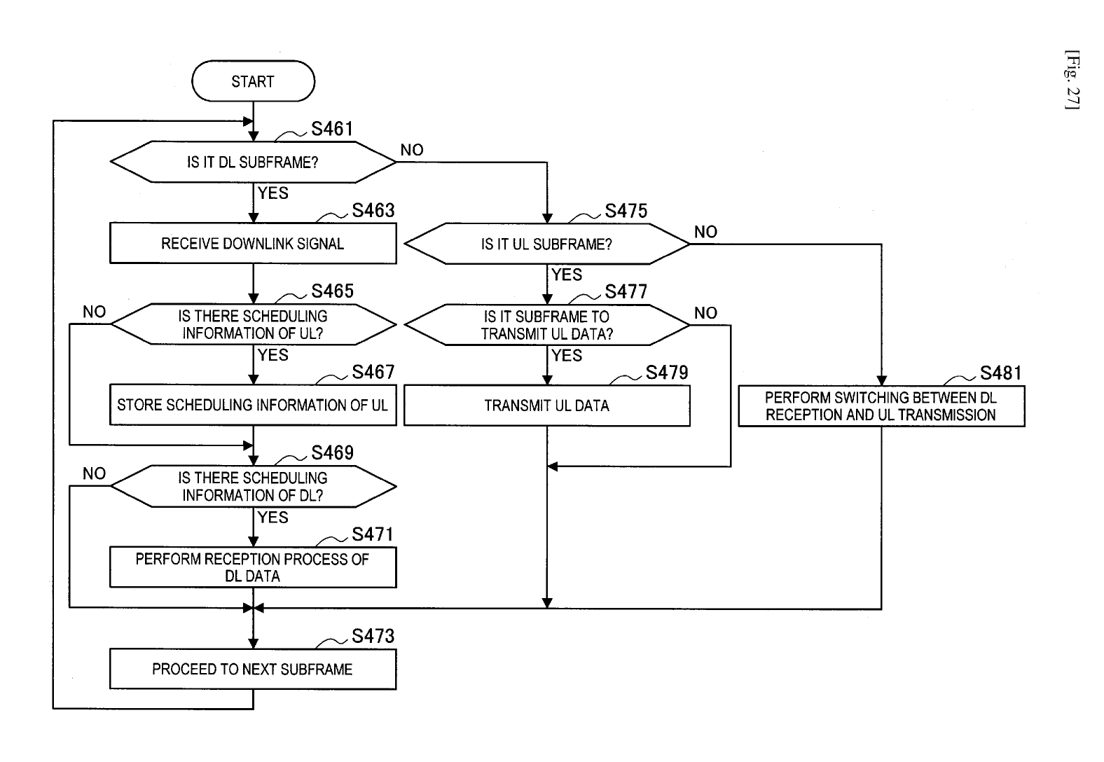

FIG. 27 is a flowchart illustrating an example of a schematic flow of a second process of the terminal device 200 according to an embodiment of the present disclosure. The second process is a process of the radio communication in the HD-FDD.

In a case where the subframe is the downlink subframe (different from a specific subframe) (YES in S461), the terminal device 200 receives the downlink signal (S463). The downlink signal includes a signal of the downlink control information transmitted through the control channel (for example, the PDCCH).

In a case where there is scheduling information of the uplink for the terminal device 200 in the downlink control information (YES in S465), the terminal device 200 stores the scheduling information of the uplink (S467).

In a case where there is the scheduling information of the downlink for the terminal device 200 in the downlink control information (YES in S469), the terminal device 200 performs the reception process of the downlink data addressed to the terminal device 200 (S471). Then, the next subframe becomes a target (S473), and the process returns to Step S461.

In a case where the subframe is not the downlink subframe (NO in S461) but the uplink subframe (different from a specific subframe) (YES in S475), and the terminal device 200 is a subframe transmitting the uplink data (YES in S477), the terminal device 200 transmits the uplink data (S479). Then, the next subframe becomes a target (S473), and the process returns to Step S461.

In a case where the subframe is not the uplink subframe (that is, the subframe is a specific subframe) (NO in S475), the terminal device 200 performs switching between the downlink reception and the uplink transmission (S481). Then, the next subframe becomes a target (S473), and the process returns to Step S461.

<<5. Modifications>>

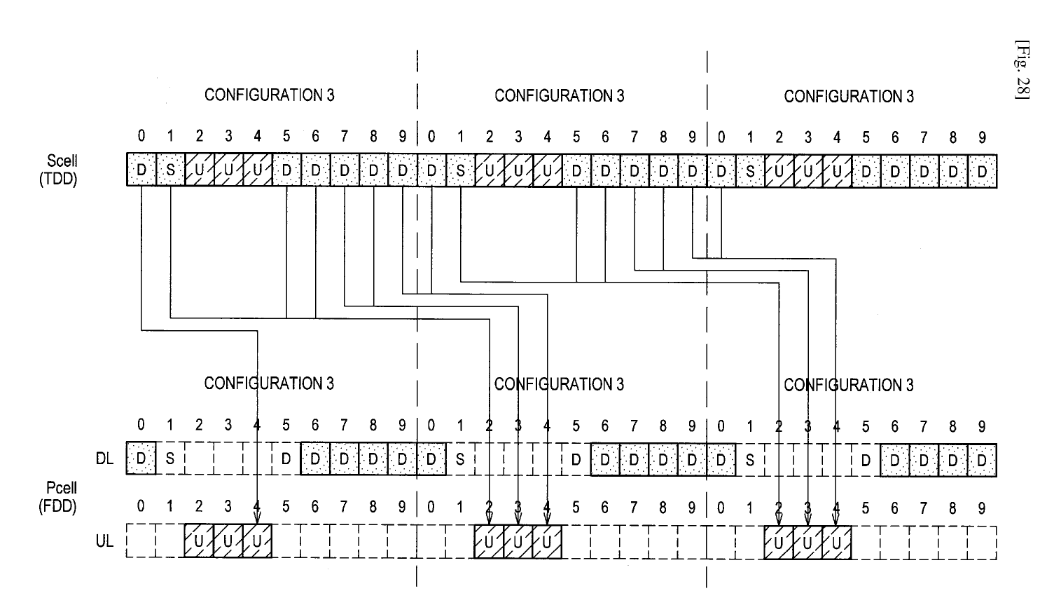

Then, first to fifth modifications according to an embodiment of the present disclosure will be described with reference to FIGS. 28 to 31.

In the modifications according to the embodiment of the present disclosure, the terminal device 200 uses the primary cell of the carrier aggregation to transmit the ACK/NACK of the downlink data transmitted to the terminal device 200 by the secondary cell of the carrier aggregation.

Further, the first to fifth modifications according to the embodiment of the present disclosure have features on the primary cell (Pcell), the secondary cell (Scell), and the selection of the UL/DL configuration of the primary cell and the secondary cell as follows.

TABLE 1

| | Base station of | Base station of | Selection of UL/DL |
|---|---|---|---|
| Modification | Pcell | Scell | Config of Pcell and Scell |
| First | Base station | Base station | — |
| | 100 | 100 | |
| Second | Base station | Base station | Selection of UL/DL |
| | (base station | (another base | Config of Pcell |
| | 100) of macro | station) of | according to UL/DL |
| | cell | small cell | Config of Scell |
| Third | Base station | Base station | Selection of UL/DL |
| | (base station | (another base | Config of Scell |
| | 100) of macro | station) of | according to UL/DL |
| | cell | small cell | Config of Pcell |
| Fourth | Base station | Base station | Selection of UL/DL |
| | (another base | (base station | Config of Scell |
| | station) of | 100) of small | according to UL/DL |
| | macro cell | cell | Config of Pcell |
| Fifth | Base station | Base station | Selection of UL/DL |
| | (another base | (base station | Config of Pcell |
| | station) of | 100) of small | according to UL/DL |
| | macro cell | cell | Config of Scell |

In a first modification, the primary cell and the secondary cell of the terminal device 200 are the component carriers (CC) of the base station 100. The terminal device 200 performs the radio communication between the base station 100 and both of the primary cell and the secondary cell. For example, the base station 100 selects the UL/DL configuration of the primary cell and the UL/DL configuration of the secondary cell.

In the second to fifth modifications, the primary cell of the terminal device 200 is the CC of the macro cell, and the secondary cell of the terminal device 200 is the CC of the small cell. The terminal device 200 performs the radio communication with the base station of the macro cell by the primary cell, and performs the radio communication with the base station of the small cell by the secondary cell.

In the second modification and the third modification, the macro cell is the cell 10 of the base station 100, and the small cell is a cell of another base station. In the second modification, the UL/DL configuration of the primary cell is selected according to the UL/DL configuration of the secondary cell. In the third modification, the UL/DL configuration of the secondary cell is selected according to the UL/DL configuration of the primary cell.

In the fourth modification and the fifth modification, the macro cell is a cell of another base station, and the small cell is the cell 10 of the base station 100. In the fourth modification, the UL/DL configuration of the secondary cell is selected according to the UL/DL configuration of the primary cell. In the fifth modification, the UL/DL configuration of the primary cell is selected according to the UL/DL configuration of the secondary cell.

<5.1. Common Features in Modifications>

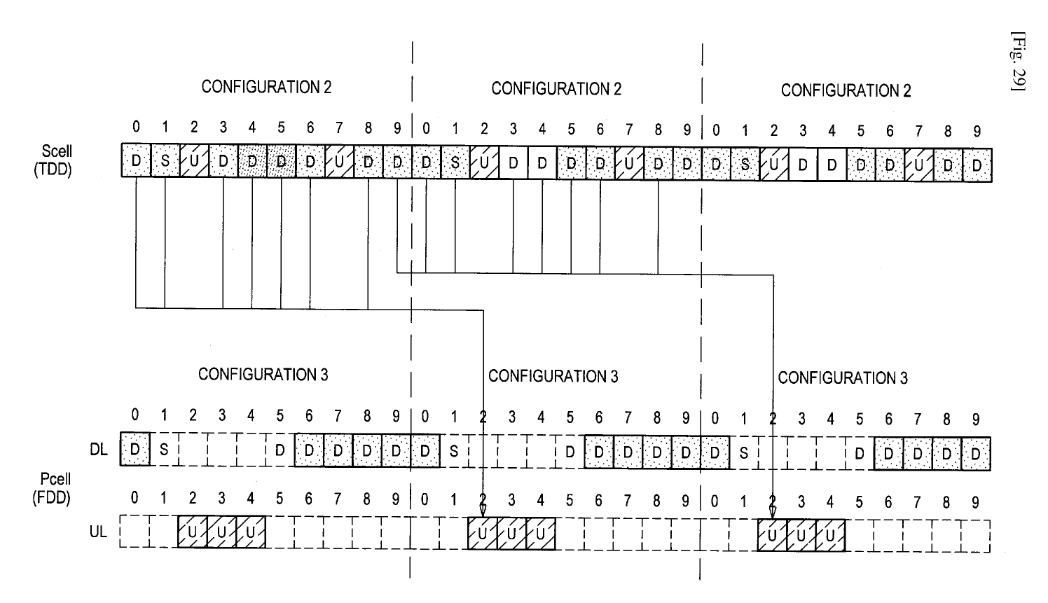

First, common features of the first to fifth modifications will be described with reference to FIGS. 28 and 29.

(Terminal Device 200)

In the modifications according to the embodiment of the present disclosure, the terminal device 200 supports the carrier aggregation. In other words, the terminal device 200 can perform the radio communication in a plurality of CCs at the same time. The plurality of CCs include one primary cell and one or more secondary cells.

For example, the terminal device 200 performs the radio communication in the primary cell and the secondary cells at the same time. Furthermore, in the primary cell, the terminal device 200 transmits the ACK/NACK of the downlink data transmitted to the terminal device 200 in the secondary cell.

(UL/DL Configuration)

(a) UL/DL Configuration Notified to Terminal Device 200 by Base Station 100

As described above, the base station 100 (the control unit 155) notifies the UL/DL configuration to the terminal device 200.

In the modifications of the embodiment of the present disclosure, the UL/DL configuration notified to the terminal device 200 by the base station 100 (the control unit 155) includes at least one of the UL/DL configuration of the primary cell of the terminal device 200 and the UL/DL configuration of the secondary cell of the terminal device 200.

(b) Relation Between the UL/DL Configuration of the Primary Cell and the UL/DL Configuration of the Secondary Cell

Furthermore, particularly in the UL/DL configuration of the primary cell according to the modifications of the embodiment of the present disclosure, a subframe in which the ACK/NACK of the downlink data transmitted according to the UL/DL configuration of the secondary cell is transmitted is determined as the uplink subframe. Therefore, for example, the terminal device 200 can transmit the ACK/NACK in the primary cell.

For example, the UL/DL configuration of the primary cell determines, as the uplink subframe, all the subframes which are determined as the uplink subframes in the UL/DL configuration of the secondary cell. Also the subframe in which the ACK/NACK is transmitted is a subframe determined as the uplink subframe in the UL/DL configuration of the secondary cell. Therefore, the terminal device 200 can transmit the ACK/NACK in the primary cell regardless of a specific subframe in which the ACK/NACK is transmitted.

As an example, the UL/DL configuration of the primary cell is the same as the UL/DL configuration of the secondary cell. Hereinafter, a specific example of such a configuration will be described with reference to FIG. 28.

FIG. 28 is an explanatory diagram for describing a first example of the transmission of the ACK/NACK according to a modification of the embodiment of the present disclosure. Referring to FIG. 28, there is illustrated the state of the uplink and the downlink of the primary cell (Pcell) and the secondary cell (Scell) of the terminal device 200. In this example, the secondary cell is the CC of the TDD, and the primary cell is the CC of the FDD. In this example, the UL/DL configuration of the primary cell and the UL/DL configuration of the secondary cell are Configuration 3. The terminal device 200 transmits the ACK/NACK of the downlink data transmitted according to Configuration 3 in the secondary cell in the ACK/NACK transmission downlink subframe corresponding to Configuration 3. In other words, the terminal device 200 transmits the ACK/NACK in the uplink subframes (having subframe numbers of 2, 3, and 4) of Configuration 3. Furthermore, in the carrier aggregation, the terminal device 200 necessarily transmits the ACK/NACK in the primary cell. In this example, since the UL/DL configuration of the primary cell is also Configuration 3, the ACK/NACK transmission downlink subframe is the uplink subframe even in the primary cell. As an example, in the secondary cell, the downlink data is transmitted to the terminal device 200 in the subframe having a subframe number of 9, and the terminal device 200 receives the downlink data. Then, the terminal device 200 transmits the ACK/NACK of the downlink data in the primary cell in the next subframe (the uplink subframe) having a subframe number of 4. In this way, the ACK/NACK is appropriately transmitted in the primary cell.

Further, as a matter of course, the UL/DL configuration of the primary cell may be not the same as the UL/DL configuration of the secondary cell. Hereinafter, a specific example of such a configuration will be described with reference to FIG. 29.

FIG. 29 is an explanatory diagram for describing a second example of the transmission of the ACK/NACK according to a modification of the embodiment of the present disclosure. Referring to FIG. 29, there is illustrated the state of the uplink and the downlink of the primary cell (Pcell) and the secondary cell (Scell) of the terminal device 200. In this example, the secondary cell is the CC of the TDD, and the primary cell is the CC of the FDD. In this example, the UL/DL configuration of the primary cell is Configuration 3. In addition, the UL/DL configuration of the secondary cell is Configuration 2. The terminal device 200 transmits the ACK/NACK of the downlink data transmitted according to Configuration 2 in the secondary cell in the subframe for transmitting the ACK/NACK predetermined for Configuration 5. In other words, the terminal device 200 transmits the ACK/NACK in the subframe (the uplink subframe of Configuration 2) having a subframe number of 2. Furthermore, in the case of the carrier aggregation, the terminal device 200 necessarily transmits the ACK/NACK in the primary cell. In this example, the UL/DL configuration of the primary cell is Configuration 3, and the ACK/NACK transmission downlink subframe (that is, the subframe having a subframe number of 2) is the uplink subframe even in the primary cell. For example, in the secondary cell, the downlink data is transmitted to the terminal device 200 in a subframe having any one of subframe numbers 0, 1, 3, 4, 5, 6, 8, and 9, and the terminal device 200 receives the downlink data. Then, the terminal device 200 transmits the ACK/NACK of the downlink data in the primary cell in the next frame (the uplink subframe) having a subframe number of 2. In this way, the ACK/NACK is appropriately transmitted in the primary cell.

(c) Subframe to Transmit ACK/NACK

The subframe in which the ACK/NACK (that is, the ACK/NACK of the downlink data transmitted according to the UL/DL configuration of the secondary cell) is transmitted is predetermined for the UL/DL configuration of the secondary cell. Specifically, for example, the subframe is defined in Table 8-2 of 3GPP TS36.213.

Therefore, according to any one of the UL/DL configuration of the primary cell and the UL/DL configuration of the secondary cell, the UL/DL configuration of the primary cell can flexibly select the other one in order to set the subframe where the ACK/NACK is transmitted as the uplink subframe.

<5.2. First Modification>

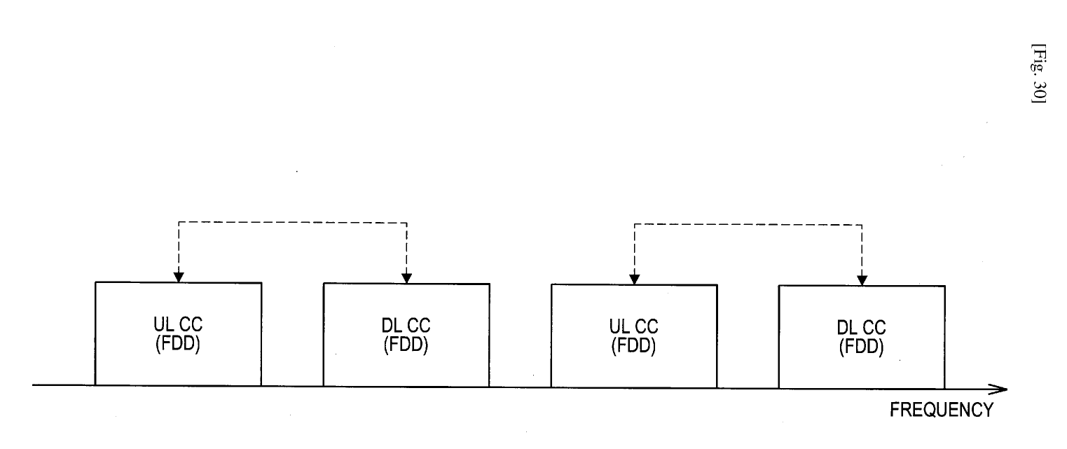

Next, a first modification of the embodiment of the present disclosure will be described with reference to FIG. 30.

(Primary Cell and Secondary Cell)

In a first modification, the primary cell and the secondary cell of the terminal device 200 are the CC of the same base station. In other words, the primary cell and the secondary cell are the CCs of the base station 100.

For example, the primary cell and the secondary cell are the CCs of the FDD. Hereinafter, a specific example of such a configuration will be described with reference to FIG. 30.

FIG. 30 is an explanatory diagram for describing an example of the primary cell and the secondary cell. Referring to FIG. 30, there are illustrated two pairs of the uplink CC and the downlink CC of the FDD. For example, the primary cell of the terminal device 200 is one of the two pairs, and the secondary cell of the terminal cell 200 is the other one of the two pairs.

(Base Station 100: Select Unit 151)

As described above, the select unit 151 selects the UL/DL configuration of the TDD.

In the first modification, the UL/DL configuration includes the UL/DL configuration of the primary cell and the UL/DL configuration of the secondary cell. In other words, the select unit 151 selects the UL/DL configuration of the primary cell of the terminal device 200 and the UL/DL configuration of the secondary cell of the terminal device 200.

Particularly, the select unit 151 selects the UL/DL configuration of the primary cell and the UL/DL configuration of the secondary cell such that the subframe in which the ACK/NACK of the downlink data transmitted according to the UL/DL configuration of the secondary cell is transmitted in the UL/DL configuration of the primary cell is determined as the uplink subframe.

(Base Station 100: Information Acquisition Unit 153)

As described above, the information acquisition unit 153 acquires the information (that is, the configuration information) indicating the UL/DL configuration.

In the first modification, the UL/DL configuration includes the UL/DL configuration of the primary cell and the UL/DL configuration of the secondary cell. In other words, the information acquisition unit 153 acquires the configuration information indicating the UL/DL configuration of the primary cell of the terminal device 200 and the configuration information indicating the UL/DL configuration of the secondary cell of the terminal device 200.

(Base Station 100: Control Unit 155)

As described above, the control unit 155 notifies the UL/DL configuration to the terminal device 200.

In the first modification, the UL/DL configuration includes the UL/DL configuration of the primary cell and the UL/DL configuration of the secondary cell. In other words, the control unit 155 notifies the UL/DL configuration of the primary cell of the terminal device 200 to the terminal device 200. In addition, the control unit 155 notifies the UL/DL configuration of the secondary cell of the terminal device 200 to the terminal device 200.

Further, for example, the control unit 155 performs the control (for example, the execution of the retransmission request process, the assignment of the radio resource, and/or the notification of the assignment of the radio resource, etc.) of the radio communication according to the UL/DL configuration on each of the primary cell and the secondary cell as described above.

Hitherto, the first modification has been described. According to the first modification, the ACK/NACK of the downlink data can be appropriately transmitted even in a case where the carrier aggregation is performed.

<6.3. Second Modification>

Next, a second modification of the embodiment of the present disclosure will be described.

(Primary Cell and Secondary Cell)

(a) Macro Cell and Small Cell

In the second modification, the primary cell of the terminal device 200 is the CC of the macro cell, and the secondary cell of the terminal device 200 is the CC of the small cell which is overlapped with the macro cell.

Furthermore, the base station of the macro cell is the base station 100, and the base station of the small cell is another base station.

Referring to FIG. 16 again, the base station 100, the cell 10 of the base station 100, the base station 30, the cell 40 and the terminal device 200 of the base station 30 are illustrated. The cell 10 is the macro cell, and the base station 100 is a base station of the macro cell. In addition, the cell 40 is the small cell which is overlapped with the cell 10 (the macro cell), and the base station 30 is a base station of the small cell. The terminal device 200 performs the radio communication with the base station 100 in the primary cell which is the CC of the cell 10 (the macro cell), and performs the radio communication with the base station 30 in the secondary cell which is the CC of the cell 40 (the small cell).

(b) Duplex Scheme

(b-1) Primary Cell

In the second modification, since the primary cell is the CC of the cell 10 (the macro cell) of the base station 100, the primary cell is the CC of the FDD.

(b-2) Secondary Cell

### First Example: TDD

As a first example, the secondary cell is the CC of the TDD.

Referring to FIG. 17 again, the pair of the uplink CC and the downlink CC of the FDD and the CC of the TDD are illustrated. For example, the primary cell of the terminal device 200 is the pair of the uplink CC and the downlink CC of the FDD, and the secondary cell of the terminal device 200 is the CC of the TDD.

### Second Example: FDD

As a second example, the secondary cell may be the CC of the FDD.

Referring to FIG. 30 again, the primary cell of the terminal device 200 may be one of the two pairs of the uplink CC and the downlink CC of the FDD, and the secondary cell of the terminal device 200 may be the other one of the two pairs.

(Base Station 100: Select Unit 151)

As described above, the select unit 151 selects the UL/DL configuration of the TDD.

In the second modification, the UL/DL configuration is the UL/DL configuration of the primary cell. In other words, the select unit 151 selects the UL/DL configuration of the primary cell of the terminal device 200.

Particularly, the select unit 151 selects the UL/DL configuration (that is, the UL/DL configuration of the primary cell) according to the UL/DL configuration of the secondary cell. In other words, the select unit 151 selects the UL/DL configuration of the primary cell such that the subframe in which the ACK/NACK of the downlink data transmitted according to the UL/DL configuration of the secondary cell is transmitted is determined as the uplink subframe.

As an example, as described with reference to FIG. 28, in a case where the UL/DL configuration of the secondary cell is Configuration 3, the select unit 151 selects Configuration 3 as the UL/DL configuration of the primary cell. As another example, as described with reference to FIG. 29, in a case where the UL/DL configuration of the secondary cell is Configuration 2, the select unit 151 selects Configuration 3 as the UL/DL configuration of the primary cell.

Further, for example, the base station 100 acquires the information indicating the UL/DL configuration of the secondary cell from the base station 30.

(Base Station 100: Information Acquisition Unit 153)

As described above, the information acquisition unit 153 acquires the information (that is, the configuration information) indicating the UL/DL configuration.

In the second modification, the UL/DL configuration is a UL/DL configuration of the primary cell. In other words, the information acquisition unit 153 acquires the configuration information indicating the UL/DL configuration of the primary cell of the terminal device 200.

(Base Station 100: Control Unit 155)

As described above, the control unit 155 notifies the terminal device 200 of the UL/DL configuration.

In the second modification, the UL/DL configuration is a UL/DL configuration of the primary cell. In other words, the control unit 155 notifies the UL/DL configuration of the primary cell of the terminal device 200 to the terminal device 200.

Further, for example, the control unit 155 performs the control (for example, the execution of the retransmission request process, the assignment of the radio resource, and/or the notification of the assignment of the radio resource, etc.) of the radio communication according to the UL/DL configuration on the primary cell as described above.

Hitherto, the second modification has been described. According to the second modification, the ACK/NACK of the downlink data can be appropriately transmitted even in a case where the carrier aggregation is performed between the base stations. In addition, according to the second modification, the UL/DL configuration of the secondary cell can be flexibly selected.

<5.4. Third Modification>

Next, a third modification of the embodiment of the present disclosure will be described.

(Primary Cell and Secondary Cell)

(a) Macro Cell and Small Cell

The third modification is not different from the second modification in the description of the macro cell and the small cell. Accordingly, the redundant description herein will be omitted.

(b) Duplex Scheme

The third modification is not different from the second modification in the description of the duplex scheme of the primary cell and the secondary cell. Accordingly, the redundant description herein will be omitted.

(Base Station 100: Control Unit 155)

In the third modification, the control unit 155 controls the selection the UL/DL configuration of the secondary cell according to the UL/DL configuration (that is, the UL/DL configuration of the primary cell).

For example, the base station 30 (the base station of the small cell) selects the UL/DL configuration of the secondary cell. In this case, the control unit 155 controls the selection of the UL/DL configuration of the secondary cell by the base station 30. Specifically, for example, the control unit 155 provides the configuration information indicating the UL/DL configuration (that is, the UL/DL configuration of the primary cell) to the base station 30. As a result, the base station 30 selects the UL/DL configuration of the secondary cell according to the UL/DL configuration.

As an example, as described with reference to FIG. 28, in a case where the UL/DL configuration (that is, the UL/DL configuration of the primary cell) is Configuration 3, the control unit 155 provides the configuration information indicating Configuration 3 to the base station 30. As a result, the base station 30 selects Configuration 3 as the UL/DL configuration of the secondary cell. As another example, as described with reference to FIG. 29, in a case where the UL/DL configuration (that is, the UL/DL configuration of the primary cell) is Configuration 3, the control unit 155 provides the configuration information indicating Configuration 3 to the base station 30. As a result, the base station 30 selects Configuration 2 as the UL/DL configuration of the secondary cell.

Further, for example, the control unit 155 performs the notification of the UL/DL configuration and/or the control (for example, the execution of the retransmission request process, the assignment of the radio resource, and/or the notification of the assignment of the radio resource, etc.) of the radio communication according to the UL/DL configuration on the primary cell as described above.

Hitherto, the third modification has been described. According to the third modification, the ACK/NACK of the downlink data can be appropriately transmitted even in a case where the carrier aggregation is performed between the base stations. In addition, according to the third modification, the UL/DL configuration of the primary cell can be flexibly selected.

<5.5. Fourth Modification>

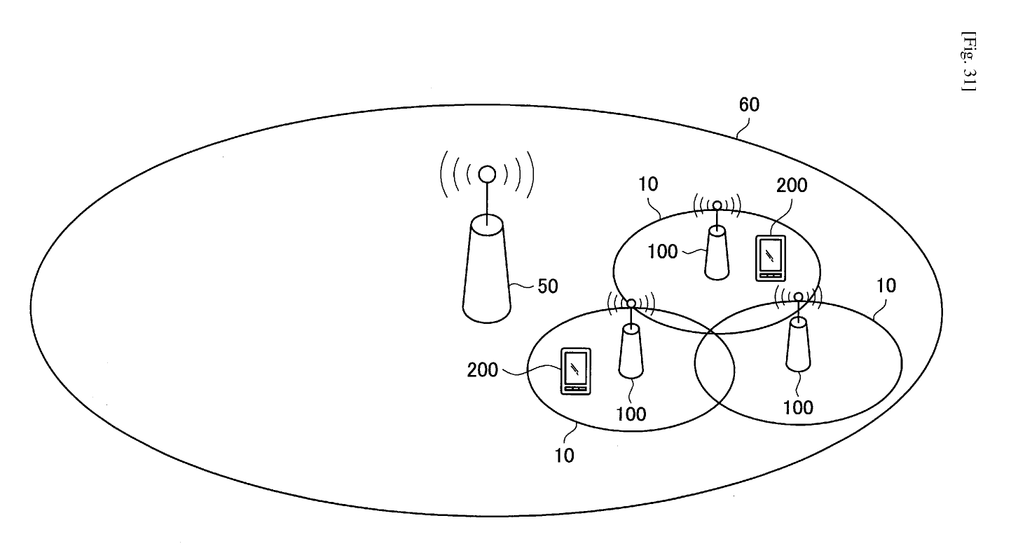

Next, a fourth modification of the embodiment of the present disclosure will be described with reference to FIG. 31.

(Primary Cell and Secondary Cell)

(a) Macro Cell and Small Cell

In the fourth modification, the primary cell of the terminal device 200 is the CC of the macro cell, and the secondary cell of the terminal device 200 is the CC of the small cell which is overlapped with the macro cell.

Furthermore, the base station of the small cell is the base station 100, and the base station of the macro cell is another base station. Hereinafter, a specific example of such a configuration will be described with reference to FIG. 31.

FIG. 31 is an explanatory diagram for describing an example of a macro cell and a small cell in the fourth modification. Referring to FIG. 31, the base station 100, the cell 10 of the base station 100, the base station 50, the cell 60 and the terminal device 200 of the base station 50 are illustrated. The cell 60 is the macro cell, and the base station 50 is a base station of the macro cell. In addition, the cell 10 is the small cell which is overlapped with the cell 60 (the macro cell), and the base station 100 is a base station of the small cell. The terminal device 200 performs the radio communication with the base station 50 in the primary cell which is the CC of the cell 60 (the macro cell), and performs the radio communication with the base station 100 in the secondary cell which is the CC of the cell 10 (the small cell).

(b) Duplex Scheme

(b-1) Secondary Cell

In a fourth modification, since the secondary cell is the CC of the cell 10 (the small cell) of the base station 100, the secondary cell is the CC of the FDD.

(b-2) Primary Cell

### First Example: FDD

As a first example, the primary cell is the CC of the FDD.

Referring to FIG. 31 again, the primary cell of the terminal device 200 is one of the two pairs of the uplink CC and the downlink CC of the FDD, and the secondary cell of the terminal device 200 is the other one of the two pairs.

### Second Example: TDD

As a second example, the primary cell may be the CC of the TDD.

Referring to FIG. 17 again, for example, the primary cell of the terminal device 200 may be the CC of the TDD, and the secondary cell of the terminal device 200 may be the pair of the uplink CC and the downlink CC of the FDD.

(Base Station 100: Select Unit 151)

As described above, the select unit 151 selects the UL/DL configuration of the TDD.

In the fourth modification, the UL/DL configuration is the UL/DL configuration of the secondary cell. In other words, the select unit 151 selects the UL/DL configuration of the secondary cell of the terminal device 200.

Particularly, the select unit 151 selects the UL/DL configuration (that is, the UL/DL configuration of the secondary cell) according to the UL/DL configuration of the primary cell. In other words, the select unit 151 selects the UL/DL configuration of the secondary cell such that the subframe in which the ACK/NACK of the downlink data transmitted according to the UL/DL configuration of the secondary cell is transmitted is determined as the uplink subframe.

As an example, as described with reference to FIG. 28, in a case where the UL/DL configuration of the primary cell is Configuration 3, the select unit 151 selects Configuration 3 as the UL/DL configuration of the secondary cell. As another example, as described with reference to FIG. 29, in a case where the UL/DL configuration of the primary cell is Configuration 3, the select unit 151 selects Configuration 2 as the UL/DL configuration of the secondary cell.

Further, for example, the base station 100 acquires the information indicating the UL/DL configuration of the primary cell from the base station 50.

(Base Station 100: Information Acquisition Unit 153)

As described above, the information acquisition unit 153 acquires the information (that is, the configuration information) indicating the UL/DL configuration.

In the fourth modification, the UL/DL configuration is a UL/DL configuration of the secondary cell. In other words, the information acquisition unit 153 acquires the configuration information indicating the UL/DL configuration of the secondary cell of the terminal device 200.

(Base Station 100: Control Unit 155)

As described above, the control unit 155 notifies the terminal device 200 of the UL/DL configuration.

In the second modification, the UL/DL configuration is a UL/DL configuration of the secondary cell. In other words, the control unit 155 notifies the UL/DL configuration of the secondary cell of the terminal device 200 to the terminal device 200.

Further, for example, the control unit 155 performs the control (for example, the execution of the retransmission request process, the assignment of the radio resource, and/or the notification of the assignment of the radio resource, etc.) of the radio communication according to the UL/DL configuration on the secondary cell as described above.

Hitherto, the fourth modification has been described. According to the fourth modification, the ACK/NACK of the downlink data can be appropriately transmitted even in a case where the carrier aggregation is performed between the base stations. In addition, according to the fourth modification, the UL/DL configuration of the primary cell can be flexibly selected.

<5.6. Fifth Modification>

Next, a fifth modification of the embodiment of the present disclosure will be described.

(Primary Cell and Secondary Cell)

(a) Macro Cell and Small Cell

The fifth modification is not different from the fourth modification in the description of the macro cell and the small cell. Accordingly, the redundant description herein will be omitted.

(b) Duplex Scheme

The fifth modification is not different from the fourth modification in the description of the duplex scheme of the primary cell and the secondary cell. Accordingly, the redundant description herein will be omitted.

(Base Station 100: Control Unit 155)

In the fifth modification, the control unit 155 controls the selection the UL/DL configuration of the primary cell according to the UL/DL configuration (that is, the UL/DL configuration of the secondary cell).

For example, the base station 50 (the base station of the macro cell) selects the UL/DL configuration of the primary cell. In this case, the control unit 155 controls the selection of the UL/DL configuration of the primary cell by the base station 50. Specifically, for example, the control unit 155 provides the configuration information indicating the UL/DL configuration (that is, the UL/DL configuration of the secondary cell) to the base station 50. As a result, the base station 50 selects the UL/DL configuration of the primary cell according to the UL/DL configuration.

As an example, as described with reference to FIG. 28, in a case where the UL/DL configuration (that is, the UL/DL configuration of the secondary cell) is Configuration 3, the control unit 155 provides the configuration information indicating Configuration 3 to the base station 50. As a result, the base station 50 selects Configuration 3 as the UL/DL configuration of the primary cell. As another example, as described with reference to FIG. 29, in a case where the UL/DL configuration (that is, the UL/DL configuration of the secondary cell) is Configuration 2, the control unit 155 provides the configuration information indicating Configuration 2 to the base station 50. As a result, the base station 50 selects Configuration 3 as the UL/DL configuration of the primary cell.

Further, for example, the control unit 155 performs the notification of the UL/DL configuration and/or the control (for example, the execution of the retransmission request process, the assignment of the radio resource, and/or the notification of the assignment of the radio resource, etc.) of the radio communication according to the UL/DL configuration on the secondary cell as described above.

Hitherto, the fifth modification has been described. According to the fifth modification, the ACK/NACK of the downlink data can be appropriately transmitted even in a case where the carrier aggregation is performed between the base stations. In addition, according to the fifth modification, the UL/DL configuration of the secondary cell can be flexibly selected.

<<6. Applications>>

Technology according to the present disclosure is applicable to various products. A base station 100 may be realized as any type of evolved Node B (eNB) such as a macro eNB, and a small eNB. A small eNB may be an eNB that covers a cell smaller than a macro cell, such as a pico eNB, micro eNB, or home (femto) eNB. Instead, the base station 100 may be realized as any other types of base stations such as a NodeB and a base transceiver station (BTS). The base station 100 may include a main body (that is also referred to as a base station device) configured to control radio communication, and one or more remote radio heads (RRH) disposed in a different place from the main body. Additionally, various types of terminals to be discussed later may also operate as the base station 100 by temporarily or semi-permanently executing a base station function. Further, at least some of structural elements of the base station 100 may be realized in the base station device or in a module for the base station device.

For example, a terminal device 200 may be realized as a mobile terminal such as a smartphone, a tablet personal computer (PC), a notebook PC, a portable game terminal, a portable/dongle type mobile router, and a digital camera, or an in-vehicle terminal such as a car navigation device. The terminal device 200 may also be realized as a terminal (that is also referred to as a machine type communication (MTC) terminal) that performs machine-to-machine (M2M) communication. Furthermore, at least some of structural elements of the terminal device 200 may be a module (such as an integrated circuit module including a single die) mounted on each of the terminals.

<6.1. Application Related to Base Station]

(First Application)

FIG. 38 is a block diagram illustrating a first example of a schematic configuration of an eNB to which the technology of the present disclosure may be applied. An eNB 800 includes one or more antennas 810 and a base station device 820. Each antenna 810 and the base station device 820 may be connected to each other via an RF cable.

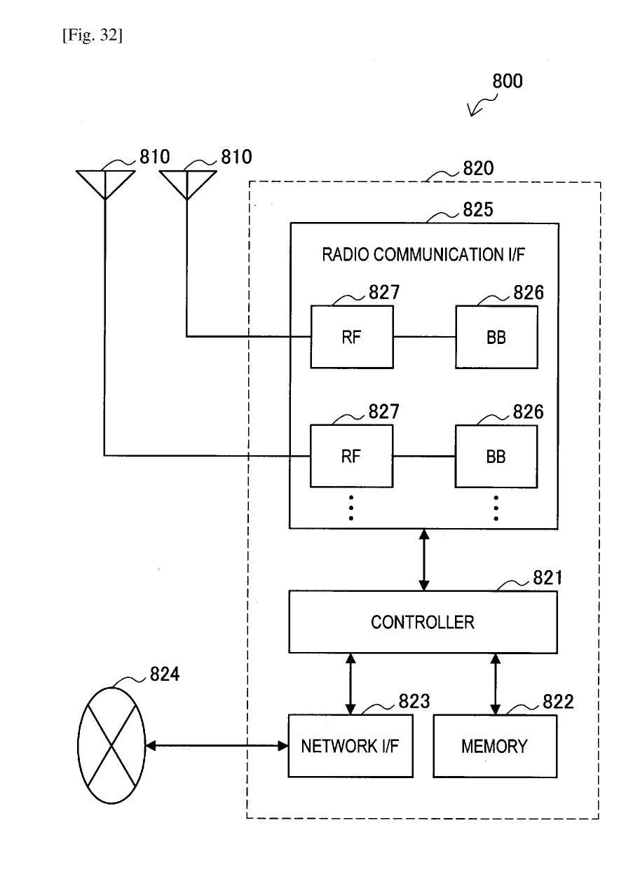

Each of the antennas 810 includes a single or multiple antenna elements (such as multiple antenna elements included in an MIMO antenna), and is used for the base station device 820 to transmit and receive radio signals. The eNB 800 may include the multiple antennas 810, as illustrated in FIG. 32. For example, the multiple antennas 810 may be compatible with multiple frequency bands used by the eNB 800. Although FIG. 32 illustrates the example in which the eNB 800 includes the multiple antennas 810, the eNB 800 may also include a single antenna 810.

The base station device 820 includes a controller 821, a memory 822, a network interface 823, and a radio communication interface 825.

The controller 821 may be, for example, a CPU or a DSP, and operates various functions of a higher layer of the base station device 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an eNB or a core network node in the vicinity. The memory 822 includes RAM and ROM, and stores a program that is executed by the controller 821, and various types of control data (such as a terminal list, transmission power data, and scheduling data).

The network interface 823 is a communication interface for connecting the base station device 820 to a core network 824. The controller 821 may communicate with a core network node or another eNB via the network interface 823. In that case, the eNB 800, and the core network node or the other eNB may be connected to each other through a logical interface (such as an S1 interface and an X2 interface). The network interface 823 may also be a wired communication interface or a radio communication interface for radio backhaul. If the network interface 823 is a radio communication interface, the network interface 823 may use a higher frequency band for radio communication than a frequency band used by the radio communication interface 825.

The radio communication interface 825 supports any cellular communication scheme such as Long Term Evolution (LTE) and LTE-Advanced, and provides radio connection to a terminal positioned in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, medium access control (MAC), radio link control (RLC), and a packet data convergence protocol (PDCP)). The BB processor 826 may have a part or all of the above-described logical functions instead of the controller 821. The BB processor 826 may be a memory that stores a communication control program, or a module that includes a processor and a related circuit configured to execute the program. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives radio signals via the antenna 810.

The radio communication interface 825 may include the multiple BB processors 826, as illustrated in FIG. 32. For example, the multiple BB processors 826 may be compatible with multiple frequency bands used by the eNB 800. The radio communication interface 825 may include the multiple RF circuits 827, as illustrated in FIG. 32. For example, the multiple RF circuits 827 may be compatible with multiple antenna elements. Although FIG. 32 illustrates the example in which the radio communication interface 825 includes the multiple BB processors 826 and the multiple RF circuits 827, the radio communication interface 825 may also include a single BB processor 826 or a single RF circuit 827.

In the eNB 800 illustrated in FIG. 32, one or more components (the select unit 151, the information acquisition unit 153, and/or the control unit 155) included in the processing unit 150 described with reference to FIG. 18 may be mounted on the radio communication interface 825. Alternatively, at least some of these components may be mounted on the controller 821. As an example, the eNB 800 may be mounted with a module containing a part (for example, the BB processor 826) or all of the radio communication interface 825, and/or the controller 821, and one or more components may be mounted in the subject module. In this case, the module may store a program for making the processor serve as the one or more components (that is, a program which makes the processor serve to execute operations of the one or more components), and execute the subject program. As another example, a program for making the processor serve as one or more components may be installed in the eNB 800, and the radio communication interface 825 (for example, the BB processor 826) and/or the controller 821 may execute the subject program. As described above, the eNB 800, the base station device 820, or the module may be provided as a device provided with the one or more components, or a program for making the processor serve as one or more components may be provided. In addition, there may be provided a readable medium in which the program is recorded.

In addition, in the eNB 800 illustrated in FIG. 32, the radio communication unit 120 described with reference to FIG. 18 may be mounted in the radio communication interface 825 (for example, the RF circuit 827). In addition, the antenna unit 110 may be mounted in the antenna 810. In addition, the network communication unit 130 may be mounted in the controller 821 and/or the network interface 823.

(Second Application)

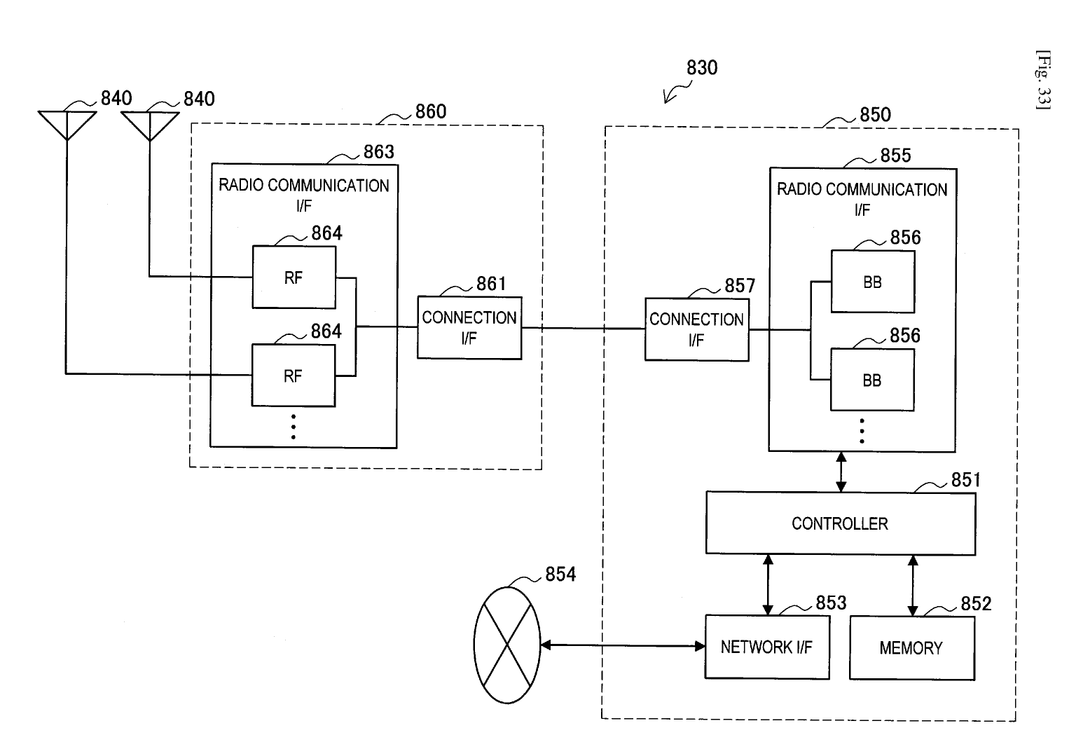

FIG. 33 is a block diagram illustrating a second example of a schematic configuration of an eNB to which the technology of the present disclosure may be applied. An eNB 830 includes one or more antennas 840, a base station device 850, and an RRH 860. Each antenna 840 and the RRH 860 may be connected to each other via an RF cable. The base station device 850 and the RRH 860 may be connected to each other via a high speed line such as an optical fiber cable.

Each of the antennas 840 includes a single or multiple antenna elements (such as multiple antenna elements included in an MIMO antenna), and is used for the RRH 860 to transmit and receive radio signals. The eNB 830 may include the multiple antennas 840, as illustrated in FIG. 33. For example, the multiple antennas 840 may be compatible with multiple frequency bands used by the eNB 830. Although FIG. 33 illustrates the example in which the eNB 830 includes the multiple antennas 840, the eNB 830 may also include a single antenna 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 32.

The radio communication interface 855 supports any cellular communication scheme such as LTE and LTE-Advanced, and provides radio communication to a terminal positioned in a sector corresponding to the RRH 860 via the RRH 860 and the antenna 840. The radio communication interface 855 may typically include, for example, a BB processor 856. The BB processor 856 is the same as the BB processor 826 described with reference to FIG. 32, except the BB processor 856 is connected to the RF circuit 864 of the RRH 860 via the connection interface 857. The radio communication interface 855 may include the multiple BB processors 856, as illustrated in FIG. 33. For example, the multiple BB processors 856 may be compatible with multiple frequency bands used by the eNB 830. Although FIG. 33 illustrates the example in which the radio communication interface 855 includes the multiple BB processors 856, the radio communication interface 855 may also include a single BB processor 856.

The connection interface 857 is an interface for connecting the base station device 850 (radio communication interface 855) to the RRH 860. The connection interface 857 may also be a communication module for communication in the above-described high speed line that connects the base station device 850 (radio communication interface 855) to the RRH 860.

The RRH 860 includes a connection interface 861 and a radio communication interface 863.

The connection interface 861 is an interface for connecting the RRH 860 (radio communication interface 863) to the base station device 850. The connection interface 861 may also be a communication module for communication in the above-described high speed line.

The radio communication interface 863 transmits and receives radio signals via the antenna 840. The radio communication interface 863 may typically include, for example, the RF circuit 864. The RF circuit 864 may include, for example, a mixer, a filter, and an amplifier, and transmits and receives radio signals via the antenna 840. The radio communication interface 863 may include multiple RF circuits 864, as illustrated in FIG. 33. For example, the multiple RF circuits 864 may support multiple antenna elements. Although FIG. 33 illustrates the example in which the radio communication interface 863 includes the multiple RF circuits 864, the radio communication interface 863 may also include a single RF circuit 864.

In the eNB 830 illustrated in FIG. 33, one or more components (the select unit 151, the information acquisition unit 153, and/or the control unit 155) included in the processing unit 150 described with reference to FIG. 18 may be mounted on the radio communication interface 825 and/or the radio communication interface 863. Alternatively, at least some of these components may be mounted on the controller 851. As an example, the eNB 830 may be mounted with a module containing a part (for example, the BB processor 856) or all of the radio communication interface 855, and/or the controller 851, and one or more components may be mounted in the subject module. In this case, the module may store a program for making the processor serve as the one or more components (that is, a program which makes the processor serve to execute operations of the one or more components), and execute the subject program. As another example, a program for making the processor serve as one or more components may be installed in the eNB 830, and the radio communication interface 855 (for example, the BB processor 856) and/or the controller 851 may execute the subject program. As described above, the eNB 830, the base station device 850, or the module may be provided as a device provided with the one or more components, or a program for making the processor serve as one or more components may be provided. In addition, there may be provided a readable medium in which the program is recorded.

In addition, in the eNB 830 illustrated in FIG. 33, for example, the radio communication unit 120 described with reference to FIG. 18 may be mounted in the radio communication interface 863 (for example, the RF circuit 864). In addition, the antenna unit 110 may be mounted in the antenna 840. In addition, the network communication unit 130 may be mounted in the controller 851 and/or the network interface 853.

<6.2. Applications related to Terminal Device>

(First Application)

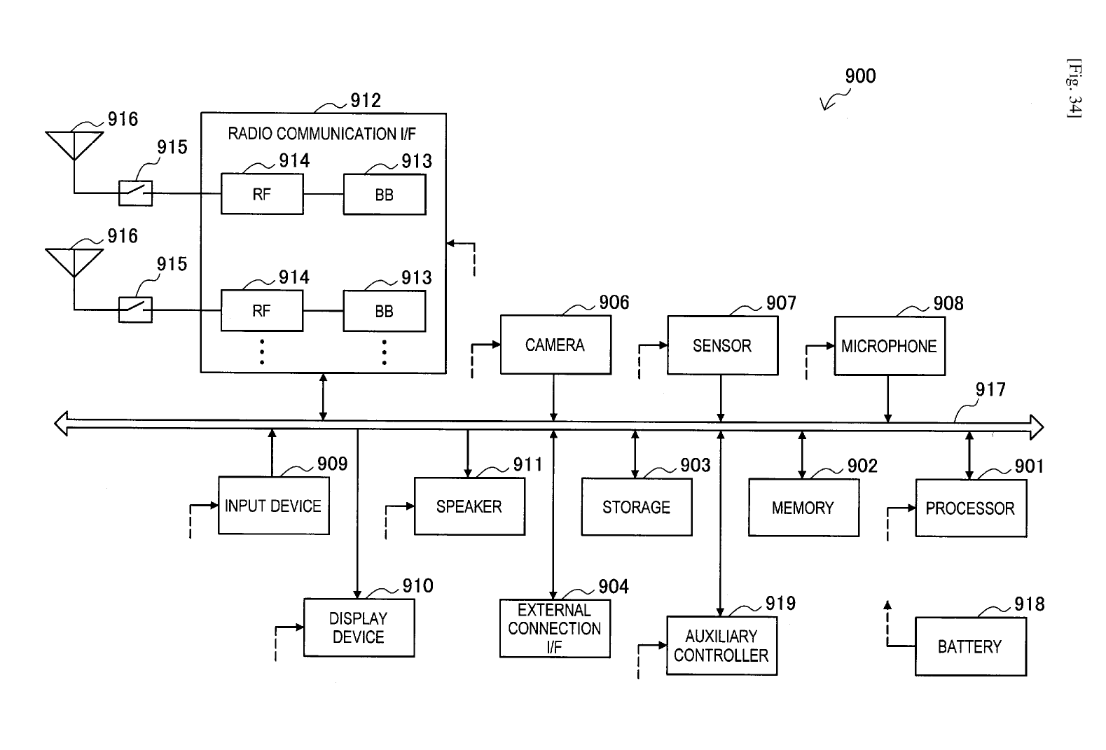

FIG. 34 is a block diagram illustrating an example of a schematic configuration of a smartphone 900 to which the technology of the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes RAM and ROM, and stores a program that is executed by the processor 901, and data. The storage 903 may include a storage medium such as a semiconductor memory and a hard disk. The external connection interface 904 is an interface for connecting an external device such as a memory card and a universal serial bus (USB) device to the smartphone 900.

The camera 906 includes an image sensor such as a charge coupled device (CCD) and a complementary metal oxide semiconductor (CMOS), and generates a captured image. The sensor 907 may include a group of sensors such as a measurement sensor, a gyro sensor, a geomagnetic sensor, and an acceleration sensor. The microphone 908 converts sounds that are input to the smartphone 900 to audio signals. The input device 909 includes, for example, a touch sensor configured to detect touch onto a screen of the display device 910, a keypad, a keyboard, a button, or a switch, and receives an operation or an information input from a user. The display device 910 includes a screen such as a liquid crystal display (LCD) and an organic light-emitting diode (OLED) display, and displays an output image of the smartphone 900. The speaker 911 converts audio signals that are output from the smartphone 900 to sounds.

The radio communication interface 912 supports any cellular communication scheme such as LTE and LTE-Advanced, and performs radio communication. The radio communication interface 912 may typically include, for example, a BB processor 913 and an RF circuit 914. The BB processor 913 may perform, for example, encoding/decoding, modulating/demodulating, and multiplexing/demultiplexing, and performs various types of signal processing for radio communication. Meanwhile, the RF circuit 914 may include, for example, a mixer, a filter, and an amplifier, and transmits and receives radio signals via the antenna 916. The radio communication interface 912 may also be a one chip module that has the BB processor 913 and the RF circuit 914 integrated thereon. The radio communication interface 912 may include the multiple BB processors 913 and the multiple RF circuits 914, as illustrated in FIG. 34. Although FIG. 34 illustrates the example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of radio communication scheme such as a short-distance wireless communication scheme, a near field communication scheme, and a radio local area network (LAN) scheme. In that case, the radio communication interface 912 may include the BB processor 913 and the RF circuit 914 for each radio communication scheme.

Each of the antenna switches 915 switches connection destinations of the antennas 916 among multiple circuits (such as circuits for different radio communication schemes) included in the radio communication interface 912.

Each of the antennas 916 includes a single or multiple antenna elements (such as multiple antenna elements included in an MIMO antenna), and is used for the radio communication interface 912 to transmit and receive radio signals. The smartphone 900 may include the multiple antennas 916, as illustrated in FIG. 34. Although FIG. 34 illustrates the example in which the smartphone 900 includes the multiple antennas 916, the smartphone 900 may also include a single antenna 916.

Furthermore, the smartphone 900 may include the antenna 916 for each radio communication scheme. In that case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 34 via feeder lines, which are partially shown as dashed lines in the figure. The auxiliary controller 919 operates a minimum necessary function of the smartphone 900, for example, in a sleep mode.

In the smartphone 900 illustrated in FIG. 34, one or more components (the information acquisition unit 241 and the control unit 243) included in the processing unit 240 described with reference to FIG. 23 may be mounted on the radio communication interface 912. Alternatively, at least some of these components may be mounted on the processor 901 and/or the auxiliary controller 919. As an example, the smartphone 900 may be mounted with a module containing a part (for example, the BB processor 913) or all of the radio communication interface 912, the processor 901, and/or the auxiliary controller 919, and one or more components may be mounted in the subject module. In this case, the module may store a program for making the processor serve as the one or more components (that is, a program which makes the processor serve to execute operations of the one or more components), and execute the subject program. As another example, a program for making the processor serve as one or more components may be installed in the smartphone 900, and the radio communication interface 912 (for example, the BB processor 913), the processor 901, and/or the auxiliary controller 919 may execute the subject program. As described above, the smartphone 900 or the module may be provided as a device provided with the one or more components, or a program for making the processor serve as one or more components may be provided. In addition, there may be provided a readable medium in which the program is recorded.

In addition, in the smartphone 900 illustrated in FIG. 34, for example, the radio communication unit 220 described with reference to FIG. 23 may be mounted in the radio communication interface 912 (for example, the RF circuit 914). In addition, the antenna unit 210 may be mounted in the antenna 916.

(Second Application)

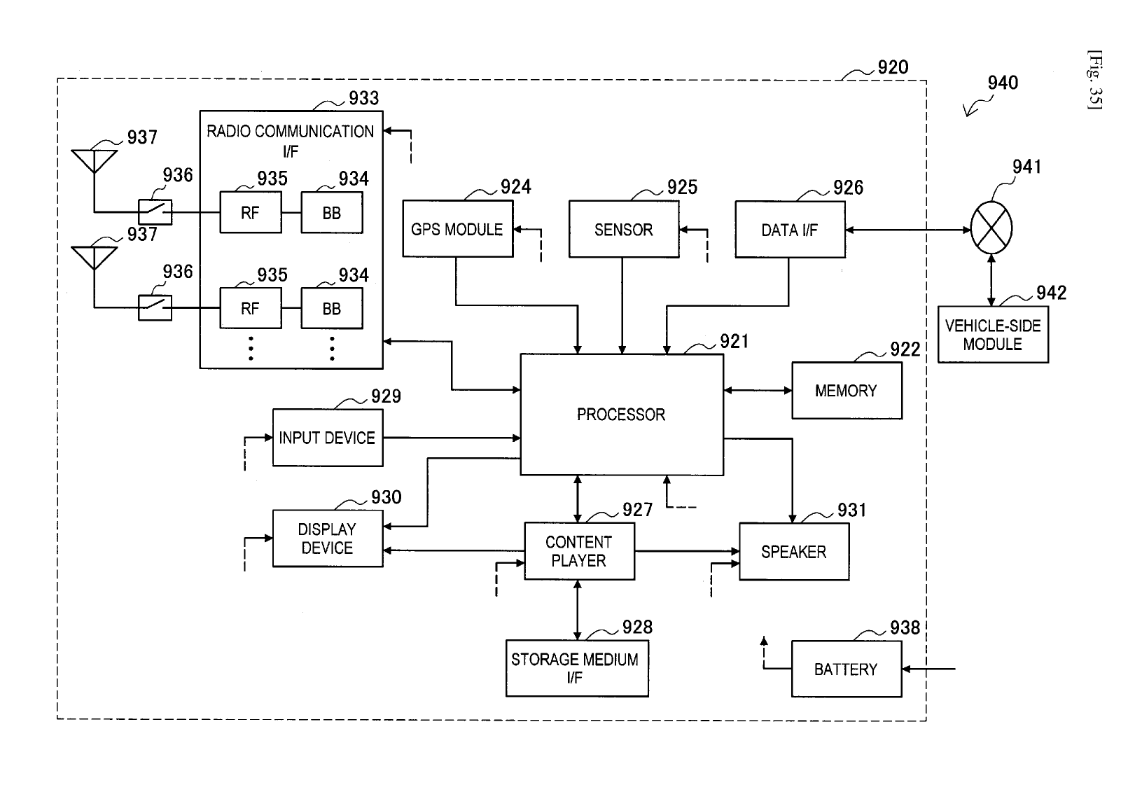

FIG. 35 is a block diagram illustrating an example of a schematic configuration of a car navigation device 920 to which the technology of the present disclosure may be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls a navigation function and another function of the car navigation device 920. The memory 922 includes RAM and ROM, and stores a program that is executed by the processor 921, and data.

The GPS module 924 uses GPS signals received from a GPS satellite to measure a position (such as latitude, longitude, and altitude) of the car navigation device 920. The sensor 925 may include a group of sensors such as a gyro sensor, a geomagnetic sensor, and an air pressure sensor. The data interface 926 is connected to, for example, an in-vehicle network 941 via a terminal that is not shown, and acquires data generated by the vehicle, such as vehicle speed data.

The content player 927 reproduces content stored in a storage medium (such as a CD and a DVD) that is inserted into the storage medium interface 928. The input device 929 includes, for example, a touch sensor configured to detect touch onto a screen of the display device 930, a button, or a switch, and receives an operation or an information input from a user. The display device 930 includes a screen such as a LCD or an OLED display, and displays an image of the navigation function or content that is reproduced. The speaker 931 outputs sounds of the navigation function or the content that is reproduced.

The radio communication interface 933 supports any cellular communication scheme such as LET and LTE-Advanced, and performs radio communication. The radio communication interface 933 may typically include, for example, a BB processor 934 and an RF circuit 935. The BB processor 934 may perform, for example, encoding/decoding, modulating/demodulating, and multiplexing/demultiplexing, and performs various types of signal processing for radio communication. Meanwhile, the RF circuit 935 may include, for example, a mixer, a filter, and an amplifier, and transmits and receives radio signals via the antenna 937. The radio communication interface 933 may be a one chip module having the BB processor 934 and the RF circuit 935 integrated thereon. The radio communication interface 933 may include the multiple BB processors 934 and the multiple RF circuits 935, as illustrated in FIG. 35. Although FIG. 35 illustrates the example in which the radio communication interface 933 includes the multiple BB processors 934 and the multiple RF circuits 935, the radio communication interface 933 may also include a single BB processor 934 or a single RF circuit 935.

Furthermore, in addition to a cellular communication scheme, the radio communication interface 933 may support another type of radio communication scheme such as a short-distance wireless communication scheme, a near field communication scheme, and a radio LAN scheme. In that case, the radio communication interface 933 may include the BB processor 934 and the RF circuit 935 for each radio communication scheme.

Each of the antenna switches 936 switches connection destinations of the antennas 937 among multiple circuits (such as circuits for different radio communication schemes) included in the radio communication interface 933.

Each of the antennas 937 includes a single or multiple antenna elements (such as multiple antenna elements included in an MIMO antenna), and is used for the radio communication interface 933 to transmit and receive radio signals. The car navigation device 920 may include the multiple antennas 937, as illustrated in FIG. 35. Although FIG. 35 illustrates the example in which the car navigation device 920 includes the multiple antennas 937, the car navigation device 920 may also include a single antenna 937.

Furthermore, the car navigation device 920 may include the antenna 937 for each radio communication scheme. In that case, the antenna switches 936 may be omitted from the configuration of the car navigation device 920.

The battery 938 supplies power to blocks of the car navigation device 920 illustrated in FIG. 35 via feeder lines that are partially shown as dashed lines in the figure. The battery 938 accumulates power supplied form the vehicle.

In the car navigation device 920 illustrated in FIG. 35, one or more components (the information acquisition unit 241 and the control unit 243) included in the processing unit 240 described with reference to FIG. 23 may be mounted on the radio communication interface 933. Alternatively, at least some of these components may be mounted on the processor 921. As an example, the car navigation device 920 may be mounted with a module containing a part (for example, the BB processor 934) or all of the radio communication interface 933, and/or the processor 921, and one or more components may be mounted in the subject module. In this case, the module may store a program for making the processor serve as the one or more components (that is, a program which makes the processor serve to execute operations of the one or more components), and execute the subject program. As another example, a program for making the processor serve as one or more components may be installed in the car navigation device 920, and the radio communication interface 933 (for example, the BB processor 934) and/or the processor 921 may execute the subject program. As described above, the car navigation device 920 or the module may be provided as a device provided with the one or more components, or a program for making the processor serve as one or more components may be provided. In addition, there may be provided a readable medium in which the program is recorded.

In addition, in the car navigation device 920 illustrated in FIG. 35, for example, the radio communication unit 220 described with reference to FIG. 23 may be mounted in the radio communication interface 933 (for example, the RF circuit 935). In addition, the antenna unit 210 may be mounted in the antenna 937.

The technology of the present disclosure may also be realized as an in-vehicle system (or a vehicle) 940 including one or more blocks of the car navigation apparatus 920, the in-vehicle network 941, and a vehicle module 942. In other words, the vehicle system (or the vehicle) 940 may be provided as an apparatus which is provided with the one or more components contained in the processing unit 240. The vehicle module 942 generates vehicle data such as vehicle speed, engine speed, and trouble information, and outputs the generated data to the in-vehicle network 941.

<<7. Conclusion>>

Hitherto, the devices and the processes according to the embodiment of the present disclosure have been described with reference to FIGS. 1 to 35.

According to an embodiment of the present disclosure, the base station 100 includes the information acquisition unit 153 which receives the information indicating the UL/DL DL configuration of the TDD and the control unit 155 which provides the UL/DL configuration to the terminal device 200. The control unit 155 controls the radio communication in the HD-FDD with the terminal device 200 according to the UL/DL configuration.

According to an embodiment of the present disclosure, the terminal device 200 includes the information acquisition unit 241 which receives the UL/DL configuration of the TDD from the base station 100, and the control unit 243 which controls the radio communication in the HD-FDD with the base station 100 according to the UL/DL configuration.

Therefore, for example, the terminal device 200 can more flexibly perform the radio communication in the cell of the FDD. More specifically, for example, the HD-FDD operation according to the UL/DL configuration of the TDD is overlapped with many parts of the operation of the TDD. Therefore, the process of the terminal device 200 can be avoided from being complicated.

Therefore, for example, the radio resource can be more flexibly assigned to the terminal device 200. More specifically, for example, the base station 100 flexibly selects the UL/DL configuration, and can share the UL/DL configuration with the terminal device 200. Therefore, the radio resource is assigned to the terminal device 200 according to the UL/DL configuration flexibly selected. In other words, the radio resource can be flexibly assigned to the terminal device 200.

It should be understood by those skilled in the art that various modifications, combinations, sub-combinations and alterations may occur depending on design requirements and other factors insofar as they are within the scope of the appended claims or the equivalents thereof.

For example, the description has been made about an example in which the base station notifying the UL/DL configuration of the TDD to the terminal device selects the UL/DL configuration, but the present disclosure is not limited to the example. For example, the UL/DL configuration may be selected by another device (for example, a core network node, another base station, etc.).

For example, the example in which the communication system is a system compliant with LTE, LTE-Advanced, or communication standards conforming thereto has been described, but the present disclosure is not limited to the example. For example, the communication system may be a system compliant with other communication standards.

Also, the processing steps in a process in this specification are not strictly limited to being executed in a time series following the sequence described in a flowchart. For example, the processing steps in a process may be executed in a sequence that differs from a sequence described herein as a flowchart, and furthermore may be executed in parallel.

In addition, a computer program (in other words, a computer program causing the processor to execute operations of components of the device) causing the processor (for example, the CPU and the DSP) included in devices (for example, the base station, the base station device, or a module for the base station device, or the terminal device or the module for the terminal device) of this specification to function as components (for example, the information acquisition unit, the control unit, and the like) of the device can be created. In addition, a recording medium in which the computer program is recorded may be provided. In addition, a device (for example, a finished product or a module (for example, a component, a processing circuit or a chip) for the finished product) including a memory in which the computer program is stored and one or more processors capable of executing the computer program may be provided. In addition, a method including operations of components (for example, the information acquisition unit and the control unit) of the device may be included in the technology according to the present disclosure.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1)

A device including:

circuitry configured to

receive information indicating an uplink/downlink configuration of a time division duplex (TDD);

provide the uplink/downlink configuration to a terminal device; and

control radio communication in a half duplex frequency division duplex (HD-FDD) with the terminal device according to the uplink/downlink configuration.

(2)

The device according to (1),

wherein the uplink/downlink configuration is individually selected for the terminal device.

(3)

The device according to (1) or (2),

wherein the circuitry provides the uplink/downlink configuration to the terminal device in a dedicated signal to the terminal device.

(4)

The device according to any one of (1) to (3),
wherein the circuitry provides the uplink/downlink configuration to the terminal device by reporting system information indicating the uplink/downlink configuration.

(5)

The device according to any one of (1) to (4),
wherein the circuitry does not assign two or more specific subframes located between one uplink subframe and one downlink subframe of the uplink/downlink configuration to the terminal device, but assigns a radio resource of another subframe different from the two or more specific subframes to the terminal device.

(6)

The device according to (5),
wherein the another subframe includes an uplink subframe or a downlink subframe of the uplink/downlink configuration, and
wherein the radio resource of the another subframe includes a radio resource of the uplink subframe of the uplink/downlink configuration among radio resources of an uplink bandwidth or a radio resource of the downlink subframe of the uplink/downlink configuration among radio resources of a downlink bandwidth.

(7)

The device according to (5) or (6),
wherein the two or more specific subframes include one or more special subframes and one or more subframes which are respectively located immediately after the one uplink subframe and immediately before the one downlink subframe.

(8)

The device according to any one of (1) to (7),
wherein the circuitry performs a retransmission request process in a manner that an ACK/NACK (Acknowledgement/Negative Acknowledgement) of uplink data transmitted from the terminal device according to the uplink/downlink configuration is transmitted to the terminal device in a downlink subframe of the uplink/downlink configuration.

(9)

The device according to (8),
wherein the circuitry performs the retransmission request process in a manner that the ACK/NACK of the uplink data is transmitted to the terminal device in the downlink subframe for the transmission of the ACK/NACK which is predetermined for the uplink/downlink configuration.

(10)

The device according to any one of (1) to (9),
wherein the circuitry notifies the terminal device that a radio resource of an uplink subframe of the uplink/downlink configuration is assigned to the terminal device in a downlink subframe predetermined for the uplink/downlink configuration.

(11)

The device according to any one of (1) to (10),
wherein the terminal device is a device having a capability of performing radio communication in the HD-FDD according to the uplink/downlink configuration of the TDD.

(12)

The device according to any one of (1) to (11),
wherein the terminal device supports carrier aggregation,
wherein the uplink/downlink configuration provided to the terminal includes at least one of the uplink/downlink configuration of a primary cell of the terminal device and the uplink/downlink configuration of a secondary cell of the terminal device, and
wherein the uplink/downlink configuration of the primary cell sets an uplink subframe, in which an ACK/NACK of downlink data transmitted according to the uplink/downlink configuration of the secondary cell is transmitted.

(13)

The device according to (12),
wherein the uplink/downlink configuration of the primary cell sets, as the uplink subframe, one of the subframes which are set as uplink subframes in the uplink/downlink configuration of the secondary cell.

(14)

The device according to (12) or (13),
wherein the uplink/downlink configuration of the primary cell is identical to the uplink/downlink configuration of the secondary cell. The device according to any one of (12) to (14),
wherein the uplink subframe in which the ACK/NACK is transmitted is predetermined for the uplink/downlink configuration of the secondary cell.

(16)

The device according to any one of (12) to (15),
wherein the uplink/downlink configuration provided to the terminal device is the uplink/downlink configuration of one of the primary cell and the secondary cell, and
wherein the other one of the primary cell and the secondary cell is a component carrier of the TDD.

(17)

The device according to any one of (12) to (16),
wherein the uplink/downlink configuration provided to the terminal device is the uplink/downlink configuration of one of the primary cell and the secondary cell, and
wherein the other one of the primary cell and the secondary cell is a component carrier of the FDD.

(18)

The device according to any one of (12) to (17),
wherein the uplink/downlink configuration provided to the terminal device is the uplink/downlink configuration of one of the primary cell and the secondary cell, and
wherein the uplink/downlink configuration provided to the terminal device is selected according to the uplink/downlink configuration of the other one of the primary cell and the secondary cell.

(19)

The device according to any one of (12) to (18),
wherein the uplink/downlink configuration provided to the terminal device is the uplink/downlink configuration of one of the primary cell and the secondary cell, and
wherein the circuitry selects the uplink/downlink configuration of the other one of the primary cell and the secondary cell according to the uplink/downlink configuration.

(20)

The device according to any one of (1) to (19),
wherein the circuitry is configured to provide a plurality of uplink/downlink configurations to a plurality of terminal devices, and
wherein each of the plurality of uplink/downlink configurations is individually selected for a different one of the plurality of terminal devices.

(21)

The device according to any one of (1) to (20),
wherein the circuitry is configured to send a request for the information indicating the uplink/downlink configuration of the TDD, and determine the uplink/downlink configuration based on the received information.

(22)

The device according to any one of (1) to (21),
wherein the received information is capability information of the terminal device.

(23)

The device according to any one of (1) to (22),
wherein the circuitry is configured to receive the information via a first wireless transmission from the terminal device, and provide the uplink/downlink configuration via a second wireless transmission to the terminal device.

(24)

A device including:
circuitry configured to receive an uplink/downlink configuration of a time division duplex (TDD) from a base station; and
control radio communication in a half duplex frequency division duplex (HD-FDD) with the base station according to the uplink/downlink configuration.

(25)

The device according to (24),
wherein the circuitry performs switching between a downlink reception and an uplink transmission by a terminal device in two or more specific subframes located between one uplink subframe and one downlink subframe of the uplink/downlink configuration.

(26)

The device according to (25),
wherein the circuitry controls the radio communication by the terminal device in a manner that the terminal device performs the downlink reception in a downlink bandwidth in a downlink subframe of the uplink/downlink configuration different from the two or more specific subframes.

(27)

The device according to (25) or (26),
wherein the circuitry controls the radio communication by the terminal device in a manner that the terminal device performs the uplink transmission in an uplink bandwidth in an uplink subframe of the uplink/downlink configuration different from the two or more specific subframes.

(28)

The device according to any one of (24) to (27),
wherein the circuitry notifies the base station that the terminal device is a device having a capability of performing the radio communication in the HD-FDD according to the uplink/downlink configuration of the TDD.

(29)

The device according to any one of (24) to (28),
wherein the circuitry performs a retransmission request process in a manner that an ACK/NACK of downlink data transmitted from the base station according to the uplink/downlink configuration is transmitted to the base station in an uplink subframe of the uplink/downlink configuration.

(30)

The device according to any one of (24) to (29),
wherein the circuitry is configured to transmit information indicating the uplink/downlink configuration, and
wherein the transmitted information is used to determine the uplink/downlink configuration.

(31)

The device according to (32),
wherein the information is capability information of a terminal device.

(32)

The device according to any one of (24) to (31),
wherein the circuitry is configured to receive the uplink/downlink configuration via a wireless transmission from the base station.

The device according to any one of (1) to (23),
wherein the terminal device supports the TDD.

(34) The device according to any one of (24) to (32),
wherein the device supports the TDD.(35)

The device according to any one of (1) to (23),
wherein the device is a base station, a base station device for the base station, or a module for the base station device.

(36)

A base station including:
an antenna; and
circuitry configured to receive information indicating an uplink/downlink configuration of a time division duplex (TDD);
provide the uplink/downlink configuration to a terminal device; and
control radio communication, via the antenna, in a half duplex frequency division duplex (HD-FDD) with the terminal device according to the uplink/downlink configuration.

(37)

A terminal device including:
an antenna; and
circuitry configured to receive an uplink/downlink configuration of a time division duplex (TDD) from a base station; and
control radio communication, via the antenna, in a half duplex frequency division duplex (HD-FDD) with the base station according to the uplink/downlink configuration.

(38)

A method including:
receiving information indicating an uplink/downlink configuration of a time division duplex (TDD);
providing, by circuitry, the uplink/downlink configuration to a terminal device; and
controlling, by the circuitry, radio communication in a half duplex frequency division duplex (HD-FDD) with the terminal device according to the uplink/downlink configuration.

(39)

A program for making a processor execute:
receiving information indicating an uplink/downlink configuration of a time division duplex (TDD);
providing the uplink/downlink configuration to a terminal device; and
controlling radio communication in a half duplex frequency division duplex (HD-FDD) with the terminal device according to the uplink/downlink configuration.

(40)

A program for making a processor execute:
receiving information indicating an uplink/downlink configuration of a time division duplex (TDD);
providing the uplink/downlink configuration to a terminal device; and
controlling radio communication in an HD-FDD with respect to the terminal device according to the uplink/downlink configuration.

(41)

The device according to any one of (24) to (32),
wherein the device is the terminal device or a module for the terminal device.

(42)

A method including:
receiving an uplink/downlink configuration of a time division duplex (TDD) from a base station; and
controlling, by circuitry, radio communication in a half duplex frequency division duplex (HD-FDD) with the base station according to the uplink/downlink configuration.

(43)

A program for making a processor execute:
receiving an uplink/downlink configuration of a time division duplex (TDD) from a base station; and
controlling radio communication in a half duplex frequency division duplex (HD-FDD) with the base station according to the uplink/downlink configuration.

(44)

A program for making a processor execute:
receiving an uplink/downlink configuration of a time division duplex (TDD) from a base station; and
controlling radio communication in a half duplex frequency division duplex (HD-FDD) with the base station according to the uplink/downlink configuration.

### REFERENCE SIGNS LIST

1 communication system
10 cell
100 base station
151 select unit
153 information acquisition unit
155 control unit
200 base station
241 information acquisition unit
243 control unit

1. A device comprising:
circuitry configured to
provide information indicating an uplink/downlink configuration of a time division duplex (TDD) to a terminal device; and
control radio communication in a half duplex frequency division duplex (HD-FDD) with the terminal device according to the uplink/downlink configuration.

2. The device according to claim 1,
wherein the uplink/downlink configuration is individually selected for the terminal device.

3-4. (canceled)

5. The device according to claim 1,
wherein the circuitry does not assign two or more specific subframes located between one uplink subframe and one downlink subframe of the uplink/downlink configuration to the terminal device, but assigns a radio resource of another subframe different from the two or more specific subframes to the terminal device.

6. The device according to claim 5,
wherein the another subframe includes an uplink subframe or a downlink subframe of the uplink/downlink configuration, and
wherein the radio resource of the another subframe includes a radio resource of the uplink subframe of the uplink/downlink configuration among radio resources of an uplink bandwidth or a radio resource of the downlink subframe of the uplink/downlink configuration among radio resources of a downlink bandwidth.

7. The device according to claim 5,
wherein the two or more specific subframes include one or more special subframes and one or more subframes which are respectively located immediately after the one uplink subframe and immediately before the one downlink subframe.

8. The device according to claim 1,
wherein the circuitry performs a retransmission request process in a manner that an ACK/NACK (Acknowledgement/Negative Acknowledgement) of uplink data transmitted from the terminal device according to the uplink/downlink configuration is transmitted to the terminal device in a downlink subframe of the uplink/downlink configuration.

9. (canceled)

10. The device according to claim 1,
wherein the circuitry notifies the terminal device that a radio resource of an uplink subframe of the uplink/downlink configuration is assigned to the terminal device in a downlink subframe predetermined for the uplink/downlink configuration.

11. (canceled)

12. The device according to claim 1,
wherein the terminal device supports carrier aggregation,
wherein the uplink/downlink configuration provided to the terminal includes at least one of the uplink/downlink configuration of a primary cell of the terminal device and the uplink/downlink configuration of a secondary cell of the terminal device, and
wherein the uplink/downlink configuration of the primary cell sets an uplink subframe, in which an ACK/NACK of downlink data transmitted according to the uplink/downlink configuration of the secondary cell, is transmitted.

13. The device according to claim 12,
wherein the uplink/downlink configuration of the primary cell sets, as the uplink subframe, one of the subframes which are set as uplink subframes in the uplink/downlink configuration of the secondary cell.

14. The device according to claim 12,
wherein the uplink/downlink configuration of the primary cell is identical to the uplink/downlink configuration of the secondary cell.

15. The device according to claim 12,
wherein the uplink subframe in which the ACK/NACK is transmitted is predetermined for the uplink/downlink configuration of the secondary cell.

16. The device according to claim 12,
wherein the uplink/downlink configuration provided to the terminal device is the uplink/downlink configuration of one of the primary cell and the secondary cell, and
wherein the other one of the primary cell and the secondary cell is a component carrier of the TDD.

17. The device according to claim 12,
wherein the uplink/downlink configuration provided to the terminal device is the uplink/downlink configuration of one of the primary cell and the secondary cell, and
wherein the other one of the primary cell and the secondary cell is a component carrier of the FDD.

18. The device according to claim 12,
wherein the uplink/downlink configuration provided to the terminal device is the uplink/downlink configuration of one of the primary cell and the secondary cell, and
wherein the uplink/downlink configuration provided to the terminal device is selected according to the uplink/downlink configuration of the other one of the primary cell and the secondary cell.

19. The device according to claim 12,
wherein the uplink/downlink configuration provided to the terminal device is the uplink/downlink configuration of one of the primary cell and the secondary cell, and
wherein the circuitry selects the uplink/downlink configuration of the other one of the primary cell and the secondary cell according to the uplink/downlink configuration.

20. The device according to claim 1,
wherein the circuitry is configured to provide a plurality of uplink/downlink configurations to a plurality of terminal devices, and
wherein each of the plurality of uplink/downlink configurations is individually selected for a different one of the plurality of terminal devices.

21. The device according to claim 1,
wherein the circuitry is configured to send a request for the information indicating the uplink/downlink configuration of the TDD, and determine the uplink/downlink configuration based on the received information.

22. (canceled)

23. The device according to claim 1,
wherein the circuitry is configured to receive the information via a first wireless transmission from the terminal device, and provide the uplink/downlink configuration via a second wireless transmission to the terminal device.

24. A device comprising:
circuitry configured to
receive an uplink/downlink configuration of a time division duplex (TDD) from a base station; and
control radio communication in a half duplex frequency division duplex (HD-FDD) with the base station according to the uplink/downlink configuration.

25. The device according to claim 24,
wherein the circuitry performs switching between a downlink reception and an uplink transmission by a terminal device in two or more specific subframes located between one uplink subframe and one downlink subframe of the uplink/downlink configuration.

26. (canceled)

27. The device according to claim 25,
wherein the circuitry controls the radio communication by the terminal device in a manner that the terminal device performs the uplink transmission in an uplink bandwidth in an uplink subframe of the uplink/downlink configuration different from the two or more specific subframes.

28. The device according to claim 24,
wherein the circuitry notifies the base station that the terminal device is a device having a capability of performing the radio communication in the HD-FDD according to the uplink/downlink configuration of the TDD.

29. The device according to claim 24,
wherein the circuitry performs a retransmission request process in a manner that an ACK/NACK of downlink data transmitted from the base station according to the uplink/downlink configuration is transmitted to the base station in an uplink subframe of the uplink/downlink configuration.

30. (canceled)

31. The device according to claim 24,
wherein the circuitry is configured to transmit information indicating the uplink/downlink configuration, and
wherein the transmitted information is used to determine the uplink/downlink configuration.

32-33. (canceled)

34. A base station comprising:
an antenna; and
circuitry configured to
receive information indicating an uplink/downlink configuration of a time division duplex (TDD);
provide the uplink/downlink configuration to a terminal device; and
control radio communication, via the antenna, in a half duplex frequency division duplex (HD-FDD) with the terminal device according to the uplink/downlink configuration.

35. A terminal device comprising:
an antenna; and
circuitry configured to
receive an uplink/downlink configuration of a time division duplex (TDD) from a base station; and
control radio communication, via the antenna, in a half duplex frequency division duplex (HD-FDD) with the base station according to the uplink/downlink configuration.
